(19) United States
(12) Patent Application Publication
(10) Pub. No.: US 2016/0009029 A1
(43) Pub. Date: Jan. 14, 2016

(54) METHODS AND APPARATUS FOR MULTIPLE MATERIAL SPATIALLY MODULATED EXTRUSION-BASED ADDITIVE MANUFACTURING

(71) Applicant: Southern Methodist University, Dallas, TX (US)

(72) Inventors: Adam Cohen, Dallas, TX (US); Paul Krueger, Plano, TX (US); David Son, Dallas, TX (US)

(21) Appl. No.: 14/796,722

(22) Filed: Jul. 10, 2015

Related U.S. Application Data
(60) Provisional application No. 62/023,604, filed on Jul. 11, 2014.

(51) Int. Cl. B29C 67/00

(52) U.S. Cl. CPC B29C 67/0085; B29C 67/0055; B29K 2083/00

(57) ABSTRACT

Methods and apparatus for multi-material extrusion-based additive manufacturing is described in which material composition and/or color can be varied locally to create abrupt transitions or controlled gradients, and in which objects may be fabricated from thermoset materials.

### TECHNICAL FIELD

This disclosure relates generally to the fields of additive manufacturing (AM), commonly known as 3-D printing, and more particularly to the field of extrusion-based additive manufacturing processes.

### BACKGROUND

Without limiting the scope of the disclosure, its background is described in connection with 3-D printing/additive manufacturing.

AM has had many achievements over the years and is currently a $3B industry. However, it has yet to achieve some of its ultimate potential. An area in which development has been limited is the production of multi-material objects. Several attempts have been made to incorporate multiple materials in a single structure using an AM system, and three companies—Objet Geometries (now Stratasys), 3D Systems, and ARBURG—have or will soon have commercial products. As important as these activities have been to promoting the state of the art in multi-material AM, they remain lacking. In particular, the ability to incorporate multiple materials at arbitrary locations in a fabricated object, with abrupt, discontinuous transitions between materials, so that composition and properties can be precisely spatially modulated on a voxel (volume element)-by-voxel basis, is very limited, as is the ability to form objects with controlled compositional gradients.

In Objet's PolyJet process (similar to 3D Systems' MultiJet Printing), photopolymer resins are inkjet printed and immediately polymerized upon deposition. Fabrication of prototypes with grayscale appearance may be obtained by jetting two different materials (e.g., black, white, translucent) in various ratios in the same location, with mixing occurring on the surface of the previous layer. By jetting materials with different hardnesses (e.g., rigid and elastomeric) onto the previous layer, a degree of intermixing occurs and a range of durometers can be obtained. However, the PolyJet process is intrinsically limited to photopolymers, which are costly and whose properties (e.g., impact resistance, biocompatibility, strength, and tear resistance) are unsuitable for some applications. Moreover, the photopolymers used must be capable of being inkjet printed (e.g., low viscosity, proper surface tension) and prototypes require significant post-processing to remove support material. Despite the excellent resolution and speed of PolyJet, the cost ($109,000-$706,000 for multi-material machines, ˜$125/kg for materials) is prohibitive vs. simpler, single-material AM equipment. ARBURG's plastic freeforming system deposits thermoplastic droplets and seems to accommodate just two materials, with no ability to mix the two. The initial cost of this machine is 120,000-150,000 euros.

Multi-color AM (in which color varies but material is essentially the same throughout) has been achieved commercially by Z Corporation (now 3D Systems) using inkjet printing of colored binder into white powder, by PolyJet, using differently-colored photopolymers, and by MCor using inkjet printing of paper. With respect to the first of these, even once infiltrated with such materials as reinforcing adhesives (e.g., cyanoacrylates) colors tend to be unsaturated. Meanwhile, Polyjet materials and equipment are very costly and material properties are lacking; MCor's process produces paper parts which are intrinsically quite weak.

Material extrusion AM—first commercialized by Stratasys Inc. in the form of Fused Deposition Modeling (FDM)—may be extended to provide a beneficial multi-material AM process. In FDM, a thermoplastic polymer filament is melted and extruded from the orifice of a nozzle (FIG. 1). The printhead moves in an X/Y path, laying down complexly-shaped extrudates that define the cross-section of each layer. In some implementations, a second material is extruded through a separate nozzle to fabricate soluble support structures as part of the building process.

Though rather low in throughput due to the serial nature of the process, material extrusion AM has in general several key benefits: 1) very low cost due to intrinsic simplicity (machines now sell for less than $1,000); 2) fabrication using robust engineering thermoplastic polymers such as ABS (Acrylonitrile Butadiene Styrene); 3) the ability to monolithically fabricate complex, multiple-component assemblies of moving parts; and 4) suitability for an office environment (i.e., safe process and materials).

Material extrusion AM lends itself well to an AM process in which multiple materials can be dispensed and mixed, including composite materials with particulates that expand the range of achievable physical properties. Moreover, material extrusion AM is ideal for processing polymers. Polymers are the very promising candidates for fabricating multiple-material functional devices as they offer a very wide range of properties, are low-cost, can have good strength-to-weight ratios, are corrosion-resistant, and are easily processed and incorporated into composites, including conductive and magnetic composites. Metals, by comparison, tend to be heavy, costly, harder to process, and often prone to corrosion. Lastly, ceramics—used in few AM processes—tend to be brittle, costly, and hard to process.

Others have considered the use of FDM to create multi-material structures. A Stratasys patent [Skubic et al., 2011] on a viscosity pump for material extrusion AM parenthetically describes the use of multiple polymer liquefiers plumbed to a single feed screw-type extruder, and notes (though doesn't claim) the potential for multi-material models. However, the system described seems incapable of rapidly (e.g., over a distance of 1 mm or less) switching between materials on the fly, especially without cross-contamination and uncontrolled gradients as would be needed for a practical system. If commercialized, its use would probably be limited to creating structures from a single blended material, or those with gradually-varying composition or color. A U.S. patent application [Oxman, 2011, #1] and publication [Oxman, 2011, #2] describe melting, mixing, and extruding multiple materials to achieve functionally graded structures. Like the Skubic application, the proposed system doesn't address the often-essential need to rapidly, abruptly, and cleanly switch materials as needed. A MakerBot U.S. patent application [Pax, 2014] discusses transitioning between materials by withdrawing one material from the printhead along its normal entry path (i.e., by reversing the filament) and replacing it with another material, but doesn't ensure there is minimal inter-contamination between materials. Indeed, it correctly assumes that materials will not remain separated and will mix, and further describes moving a “transition region” (i.e., mixed material) out of the printhead. However, it seems to make no provision for (albeit wastefully) disposing of the mixed material and not re-introducing it into the printhead. Another MakerBot U.S. patent application [Boyer et al., 2014] discusses methods of moving transitions/mixed material regions away from object surfaces so as to hide/bury them on the interior of the object. While this may be acceptable for transitions involving a change in appearance (e.g., color), it is often not acceptable for those involving changes in material properties, as the particular functionality different materials provide is usually not confined to visible surfaces. Neither MakerBot application provides any specific approach for rapid mixing of viscous materials to achieve blended properties.

It might be assumed that multi-material structures could be produced by simply extending the conventional FDM process to multiple nozzles, and some FDM-based machines include two or three nozzles, each fed by a different filament. However, such approaches do not provide inter-mixing between materials and are thus limited to just a few materials, nor can they tightly control gradation for functionally graded structures. One AM system, from botObj ects Ltd., uses five filaments—each of a different color—fed into a common printhead, and extrudes from a nozzle a gradually-changing mixture of colors. However, no provision is made to avoid cross-contamination and achieve rapid transitions. Moreover, only color variation is provided, not modulation of useful material properties such as hardness or stiffness.

Thermosets and elastomers. The use of thermoset materials in AM has been minimal, despite several established benefits and wide industry use in general. The exception is the relatively inferior class of photocurable thermosets used in stereolithography and the PolyJet process such as acrylates and epoxies. Also noteworthy is the relative paucity and poor properties of elastomeric materials in AM, despite their widespread utility in products ranging from medical devices, to gaskets, to cookware, to molds. Elastomeric materials are commercially available so far in the PolyJet, selective laser sintering, and MultiJet Printing AM processes, but the range of properties is limited and strength of the materials is poor. For example, according to material data sheets, PolyJet elastomers with durometers of 26-28 and 40 Shore A have tensile strengths 4-6 times lower, and tear strengths 6-9 times lower, than NuSil liquid silicone elastomers (i.e., polysiloxane) of similar durometers, therefore greatly limiting their usefulness. Moreover, elongation to break of PolyJet elastomers is significantly lower (e.g., 20-45% of that typically found with silicone elastomers). Comparing SLS and silicone elastomers of similar durometer, a similar large discrepancy in properties such as tear strength and elongation is noted: approximately 4-5 times worse for SLS, though this discrepancy can reduced somewhat by infiltrating the porous SLS object with a suitable liquid. Recently, elastomer filaments for FDM have been marketed; however, they are relatively hard (e.g., 75 shore A durometer or higher).

Overall, thermally-cured silicone elastomers have excellent properties such as chemical resistance, flexibility, wide service temperature range, and moisture and ultraviolet light resistance, and excellent medically-relevant properties such as long-term implantability, sterilizability, and gas and drug permeability. Some [Periard et al., 2007] have experimented with extruding RTV (room temperature vulcanizing) silicones from a nozzle, but the resulting structures are poorly-defined and the materials lack biocompatibility. Others, such as Hyrel L.L.C. (Norcross, GA) are experimenting with ultraviolet light-cured silicone and recently introduced cold and warm extrusion heads with provision for photoinitiated crosslinking However, materials containing photoinitiators typically have limited biocompatibility.

Recently, Fripp Design (United Kingdom) and the University of Sheffield have developed a process using MIT's “3D Printing” inkjet-deposited binder and powder process to create soft tissue prosthetics by fabricating delicate starch-based preforms, infiltrating them with silicone, and curing. Such composites would not however, be implantable, and as conceded by Fripp, their durability and mechanical properties are limited. Moreover, the material properties such as hardness cannot be spatially-modulated with this approach. Using more biocompatible thermally-cured silicones in a stereolithography-like process, with localized heating provided by an IR laser, would (if attempted) waste unused material in the vat (which would eventually solidify) and does not allow spatially-modulated composition. More recently, Fripp has developed a process (International application number PCTlGB2014/053190) for silicone AM in which a needle deposits one part of a two-part silicone into a bath of the second part, with the two liquids reacting and curing. This process has several limitations, however, including: the inserted nozzle and deposited liquid may disturb already-cured regions of the object and create nonuniformities in layer thickness; inadequate mixing of the two materials; applicability only to certain types of silicones; a limited range over which properties can be spatially modulated since only one of two components can be varied; poor feature definition due to diffusion; incomplete curing resulting in tacky surfaces or interior volumes; the need to wash, rinse, and dry objects before use; difficulty removing uncured silicone from long, narrow channels or large internal volumes through small holes; and imperfectly-established neutral buoyancy and fixation of the object during fabrication, leading to layer misalignment and other distortions (so that supports cannot entirely be eliminated as claimed).

A recent paper [Hardin et al., 2015] describes microfluidic printhead for dispensing two polydimethylsiloxane-based inks through a single nozzle. This printhead provides for no mixing or intentional grading of materials, while transitions between materials which are ideally abrupt are in fact somewhat graded, especially at low flow rates. Moreover, transitions at high flow rates can be challenging because one has to start and stop the flow quickly.

### SUMMARY

The disclosure describes multiple-material AM methods and apparatus for point-of-use metering, micro-mixing, and extrusion of multiple materials, with the ability to abruptly transition between materials as well as create functionally graded properties through continuous variation of properties. Using these methods and apparatus, material composition and properties can be modulated locally and arbitrarily throughout the volume of a heterogeneous and/or anisotropic fabricated object according to a digital design. The disclosure further describes methods and apparatus for AM involving thermal curing of thermoset materials such as silicones, allowing high-quality elastomer objects to be produced. It further comprises methods and apparatus for AM involving thiol-ene materials. Other novel aspects described in the disclosure include: precision micro-blending and extrusion methods and apparatus providing microscale, rapid inter-mixing of liquids including high-viscosity materials; and methods, apparatus, and processing and control methodologies comprising purging and extrusion/deposition to enable rapid transitions with minimal cross-contamination. In some embodiments, objects are additively manufactured at least in part from thermoplastic materials such as ABS, nylon, and polylactic acid as the feedstock, while in other embodiments, objects are additively manufactured at least in part from thermoset materials such as silicone rubber, epoxy, polyimide, polyester, vinylester, phenolic, polyurethane, or various rubbers (the last of which may require vulcanization to achieve the desired properties).

The disclosure describes methods and apparatus for deposition of multiple, dissimilar materials with high spatial resolution (e.g., 50-300 μm) in material composition, sharp boundaries between different material volumes, and controlled cross-contamination. By offering precision control over material composition, the design space for objects made with AM is greatly increased. In the case of thermoplastic materials, multiple thermoplastic materials (e.g., in the form of a filament) are controllably fed into a printhead having a point-of-use microfluidic mixing chamber (MMC). In the case of non-thermoplastic (e.g., thermoset) materials, multiple thermoset components in a flowable form (e.g., liquid) are controllably metered into a printhead having a point-of-use microfluidic mixing chamber. In either case, the materials are blended homogeneously in the chamber in the desired proportions and extruded, whereupon they solidify (through cooling if thermoplastic, or through rapid thermal curing or other means if thermoset) to form a portion of a layer. The printhead can blend multiple compatible materials having different properties (e.g., modulus of elasticity), producing composites with properties determined by the source materials and their mixing ratio(s).

The printhead can operate continuously, producing long extrudates (FIG. 2, left) or short and “micro” extrudates (FIG. 2, right) of pure material or of mixed material, the latter with a blend ratio which can be held constant or vary gradually and continuously. In FIG. 2, the various materials are depicted in various colors; these can indicate actual variations in visual appearance (e.g., colors, different gray levels) of a single material and/or indicate different materials. In the case of long and short extrudates, materials are mixed and extruded simultaneously and continuously; this is similar to conventional FDM but with point-of-use mixing of multiple materials. When an abrupt transition in color or material is required, the printhead can operate in an alternative mode, in which material in the MMC is ejected virtually completely before new material is introduced, to minimize cross-contamination. If required, abrupt transitions can follow one another in rapid succession with the printhead operating in a pulsed, purging mode, dynamically depositing extrudates such as micro extrudates (FIG. 2, right). A micro extrudate can have approximately the volume of the MMC (e.g., tens-hundreds of nanoliters) and be composed of pure or mixed material. In this mode, material can be thoroughly blended if needed during one portion of a cycle, and extruded during another portion; a cycle can be completed in a short time (e.g., milliseconds or tens of milliseconds). Long, short, and micro extrudates can be deposited in arbitrary order along a toolpath.

It is an object of some embodiments of the subject matter described here to provide a multi-material extrusion-based additive manufacturing process and apparatus which can fabricate objects comprising multiple materials.

It is an object of some embodiments of the subject matter described here to provide a multi-material extrusion-based additive manufacturing process and apparatus which can fabricate objects with multiple shades of gray or multiple colors.

It is an object of some embodiments of the subject matter described here to provide a multi-material extrusion-based additive manufacturing process and apparatus which can fabricate objects from at least one functionally graded material.

It is an object of some embodiments of the subject matter described here to provide a multi-material extrusion-based additive manufacturing process and apparatus wherein the transition between one material or property and an adjacent material or property, along the axis of a single extrudate, can be abrupt and discontinuous, with no waste of material.

It is an object of some embodiments of the subject matter described here to provide a multi-material extrusion-based additive manufacturing process and apparatus wherein the transition between one material or property and an adjacent material or property, along the axis of a single extrudate, can be gradual and continuous.

It is an object of some embodiments of the subject matter described here to provide an extrusion-based additive manufacturing process and apparatus which can fabricate objects from thermoset materials.

It is an object of some embodiments of the subject matter described here to provide a multi-material extrusion-based additive manufacturing process and apparatus which can fabricate structures from well-mixed materials.

It is an object of some embodiments of the subject matter described here to provide an extrusion-based additive manufacturing process and apparatus which can fabricate objects from thiol-ene materials.

It is an object of some embodiments of the subject matter described here to provide an extrusion-based additive manufacturing process and apparatus which can fabricate drug-delivery implants.

Other objects and advantages of various embodiments of the subject matter described here will be apparent to those of skill in the art upon review of the teachings herein. The various embodiments of the subject matter described here, set forth explicitly herein or otherwise ascertained from the teachings herein, may address one or more of the above objects alone or in combination, or alternatively may address some other object ascertained from the teachings herein. It is not necessarily intended that all objects be addressed by any single aspect of the subject matter described here even though that may be the case with regard to some aspects. Other aspects of the subject matter described here may involve combinations of the above noted aspects of the subject matter described here. These other aspects of the subject matter described here may provide various combinations of the aspects presented above as well as provide other configurations, structures, functional relationships, and processes that have not been specifically set forth above.

### DESCRIPTION OF DRAWINGS

FIG. 1 is a 3-D view of a system for fused deposition modeling (prior art).

FIG. 2 is a 3-D view of extrudates of different lengths.

FIG. 3 is a 3-D view of a deposition head.

FIG. 4 is a cross-sectional 3-D view of a deposition head using thermoplastic filaments.

FIG. 5 is schematic front view of apparatus used in some embodiments.

FIG. 6 is a cross-sectional 3-D view of a deposition head for thermoset materials.

FIG. 7 depicts cross-sectional elevation views of phases in a multi-material deposition process.

FIG. 8 depicts the chemical structure of thiol-ene components.

FIG. 9 depicts 3-D views of a microfluidic mixing chamber and a diagraph showing possible streamlines.

FIG. 10 depicts in cross-sectional elevation view a printhead with a plunger tip and microfluidic mixing chamber which are hemispherical.

FIG. 11 depicts in cross-sectional elevation view a rotating nozzle mixing extrudate.

FIG. 12 depicts in cross-sectional elevation views of several approaches to heating a thermoset material.

FIG. 13 depicts in cross-sectional elevation views of a printhead for cooking and curing materials.

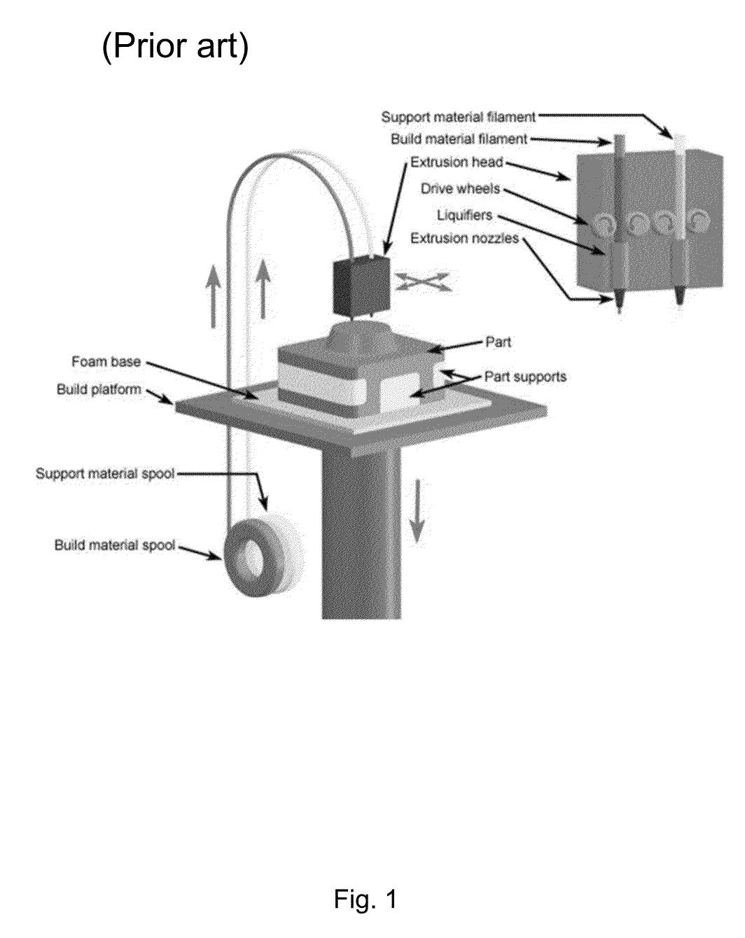

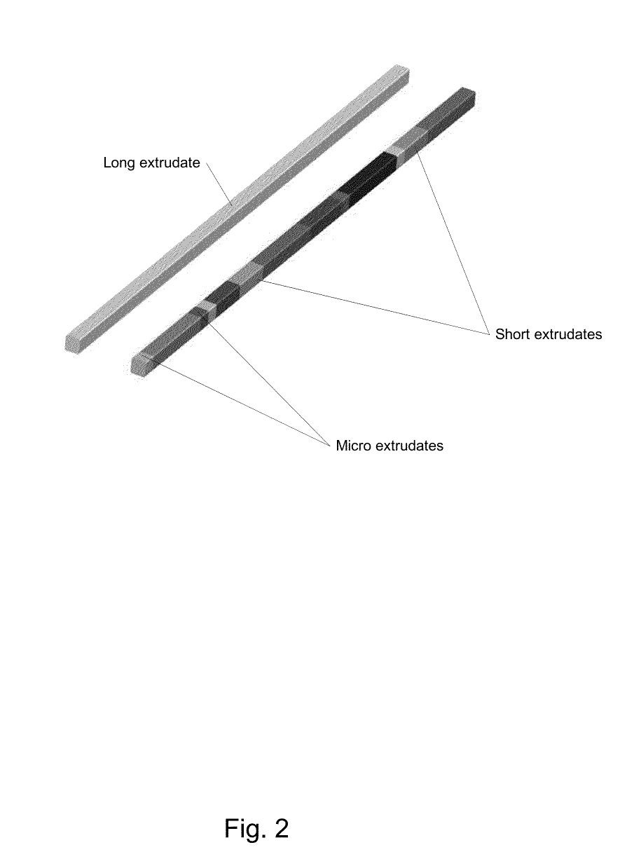

Like reference symbols in the various drawings indicate like elements.

### DETAILED DESCRIPTION

Apparatus

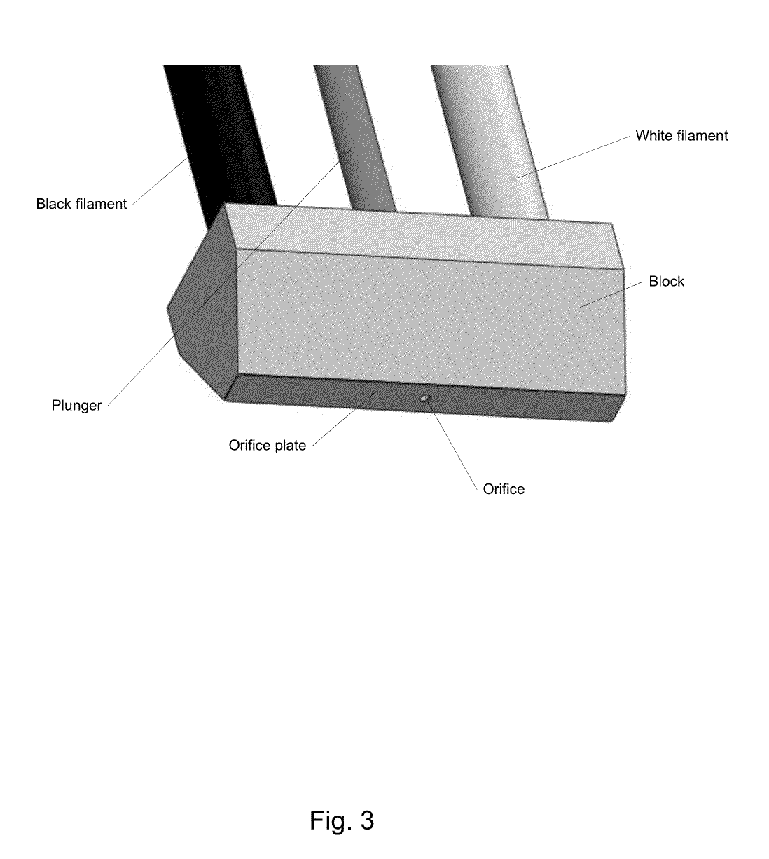

FIG. 3 is an exterior 3-D view of a printhead used in some embodiments for deposition of multiple thermoplastic materials. As shown, two thermoplastic materials are provided in filament form. For clarity, one is shown as white and one as black; however, these do not necessarily represent specific colors, and if they do, it not to the exclusion of other colors which may be used. The materials may also be clear, or the materials may have the same color, but different properties (e.g., different hardness or elastic modulus), etc. In some embodiments, more than two filaments may be provided. Also shown in the figure are a plunger and an orifice plate having an orifice. In some embodiments the orifice plate may not be flat externally as depicted, but may have an externally-conical shape typical of FDM printhead nozzles, or another shape. In lieu of a plunger, another means of provide displacement, such as a diaphragm, bellows, or screw may be used in some embodiments.

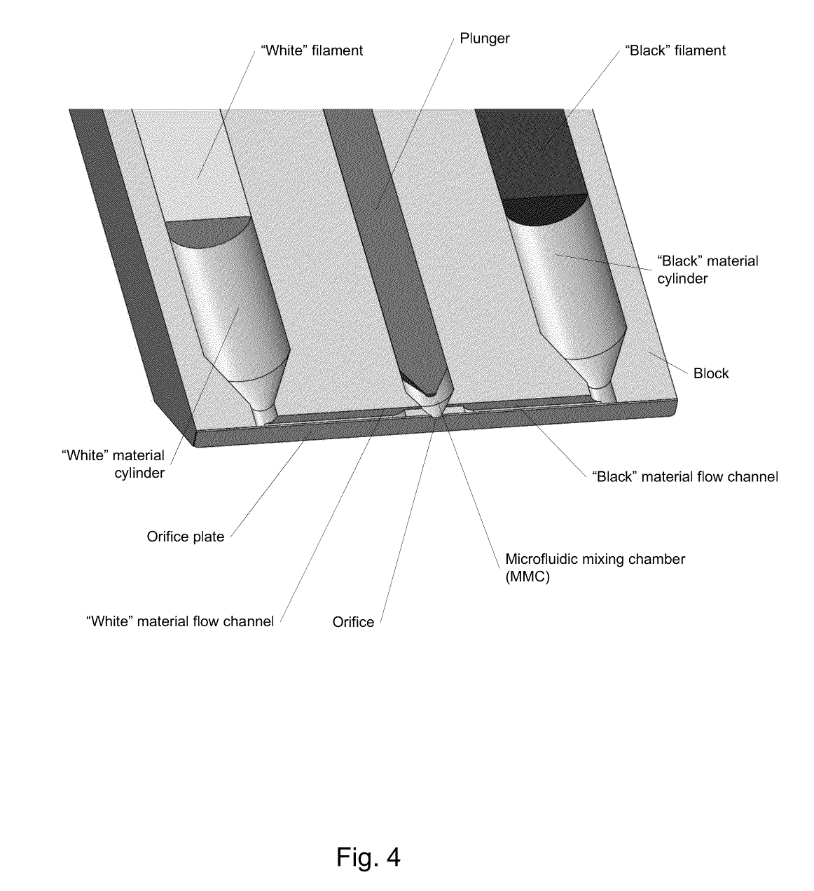

FIG. 4 shows a cross-sectional 3-D view of the printhead of FIG. 3. The head comprises a block which may be machined from aluminum or other material. Filaments are precisely fed into cylinders within the block, e.g., by rollers, drive wheels, or gears (not shown). At least the lower portion of the block is heated to a desired temperature to melt the thermoplastic using cartridge heaters (not shown) or other means, e.g., using a closed loop temperature control system using a thermistor, thermocouple, or other sensor for feedback. In some embodiments, the block comprises thermal isolating elements between the two cylinders and separate heaters, individually controlled in temperature, such that different materials may be melted at different temperatures.

Upon heating, molten material fills each cylinder. Advancing the unmelted filaments, which serve as pistons, forces molten materials into the “white ” and “black” material flow channels, and from there to an MMC provided within the block. As shown, the MMC is conical, but may be hemispherical, cylindrical (with a flat end), or have other shapes. At the bottom of the MMC is an orifice plate (e.g., thin electroformed nickel) with an orifice; in some embodiments, the orifice may be provided as part of the block. In some embodiments, other methods of extruding thermoplastic materials, supplied either as filaments or in other forms, may be used, for example, screw extruders, gear pumps, and heated syringe pumps.

Also located within the MMC is a plunger, which can rotate around its longitudinal axis as well as translate along this axis (e.g., driven by a voice coil actuator). In some embodiments the lower end is terminated by a disk-shaped nub which can enter the orifice if it is of cylindrical geometry; in other embodiments, the orifice is conical or hemispherical in shape and the lower end of the plunger can enter it substantially without a nub. The plunger has several potential functions: 1) providing a top to the MMC and optionally varying MMC volume by its position; 2) rotating to help intermix the materials as will be described below; 3) purging the MMC (by descending fully, e.g., with the nub on the plunger extended through the orifice); 4) cutting off material flow into the MMC (by descending); and optionally, 5) stopping flow from the orifice before the printhead makes large jumps, minimizing the risk of “stringers” (thin strands of polymer, which can be located so as to distort the fabricated object's intended shape or surface finish). In some embodiments the plunger comprises a conical (as shown) or hemispherical lower end. The plunger can rotate, if required, at high speeds (e.g., 100,000 RPM), e.g., driven by a high-speed electric or pneumatic motor, providing mixing of relatively high-viscosity materials such as molten ABS (Acrylonitrile butadiene styrene) at low Re (Reynolds number) in the small volume of the MMC. In some aspects, the MMC/plunger combination is similar to macro-scale viscous-drag disk extruders, while in other aspects, the printhead resembles and operates similarly to drop-on-demand inkjet printheads. The orifice is relatively small in diameter compared with the MMC, and material may be retained in the MMC before extrusion in part by surface tension, and in some embodiments by already-extruded material blocking the orifice.

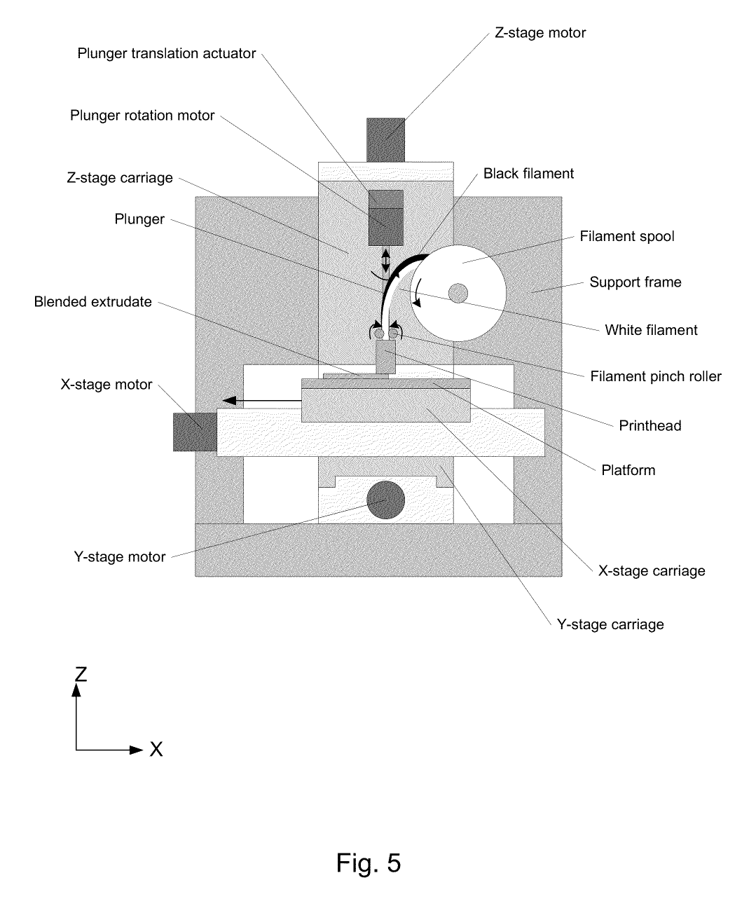

FIG. 5 shows a simplified implementation of apparatus for fabricating multi-material objects. The apparatus comprises a support frame with motorized stages for the X, Y, and Z axes. A platform on which the object is built is transported in X and Y by stages, while the printhead is translated along the Z axis. Other equivalent arrangements are also possible in some embodiments. Above the platform is mounted the printhead, from which extrudate issues onto the platform or previous layer. Entering the printhead are two filaments (e.g., 1.75-mm diameter ABS)—one black and one white—stored on spools, each of which is fed into the printhead by a pair of small motorized rollers. The plunger is actuated in translation along Z by an actuator and rotated around its longitudinal axis by a motor. Both the actuator and motor may be affixed to the Z axis stage. Not shown (among other elements) is the control system.

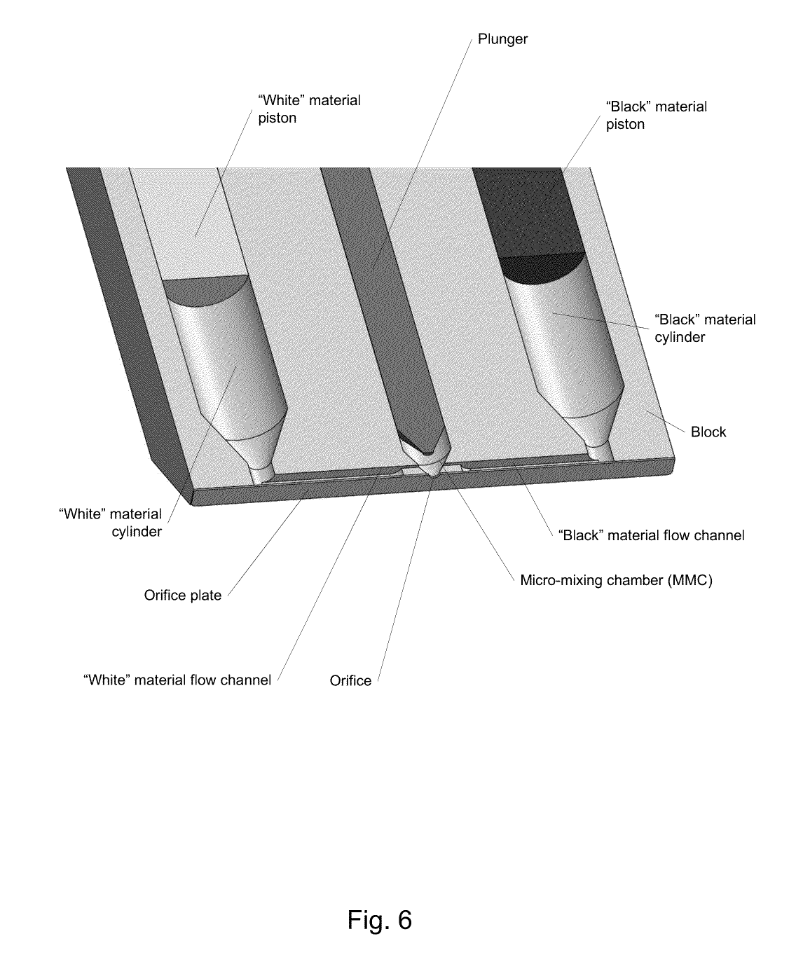

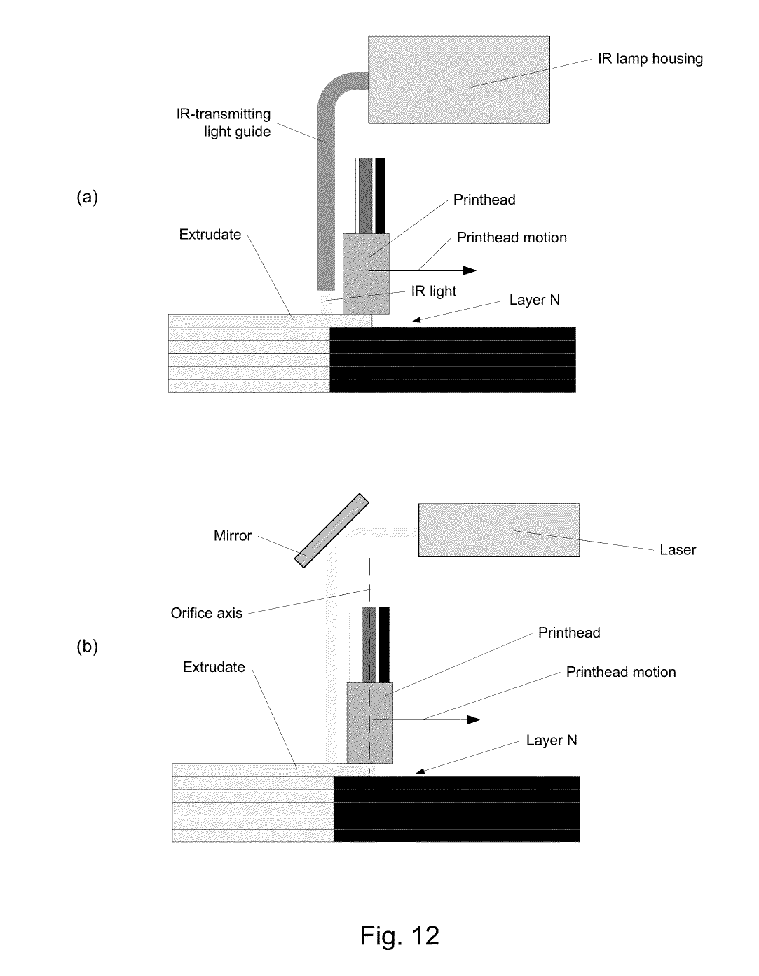

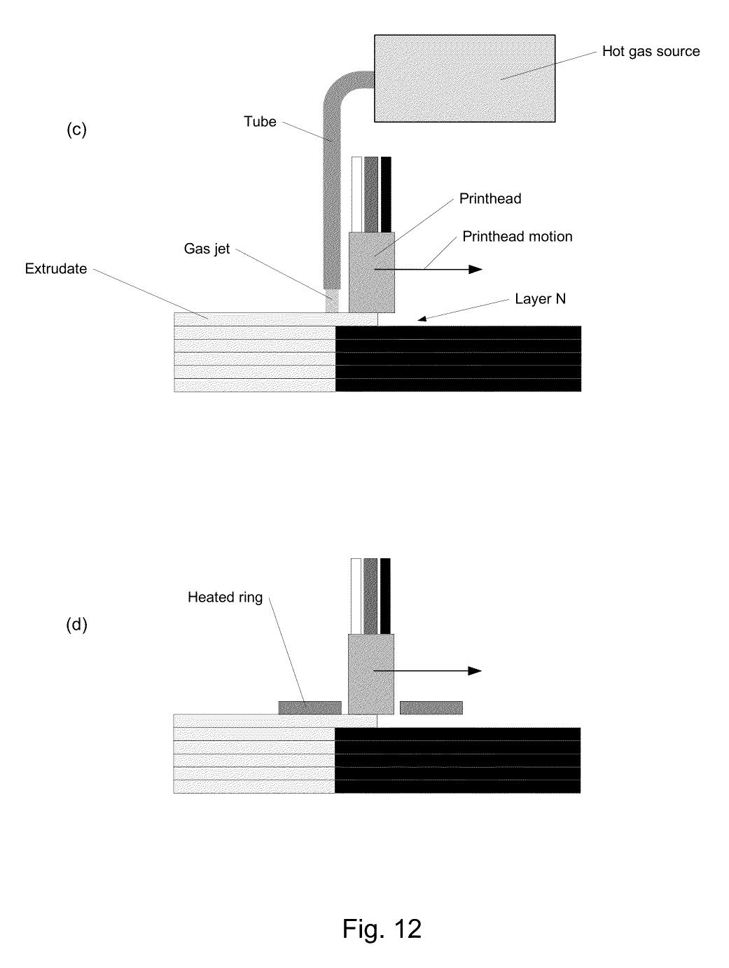

FIG. 6 depicts a similar printhead to that of FIGS. 3-4, but adapted to deposit non-thermoplastic materials such as thermoset materials. Here the printhead similarly comprises a block with cylinders and flow channels for each material. However, within each cylinder are pistons which pressurize and feed materials within the cylinders through the flow channels, into the MMC, and out through the orifice. In some embodiments, the pistons and cylinders may be separate and remote from the printhead, with material flowing into the printhead through tubing, while in other embodiments other methods of pumping the material, such as gear pumps, diaphragm pumps, and peristaltic pumps may be used. In some embodiments, the printhead cylinders may be at an angle to the vertical and the orifice may be at the tip of a tube or other nozzle, so as to minimally obstruct the extruded material from heated gas, light, or other means of curing, some of which are shown in FIG. 12. As before, rotation of the plunger allows rapid mixing of relatively high-viscosity materials such as silicones at low Re in the small volume of the MMC.

Methods of Operation

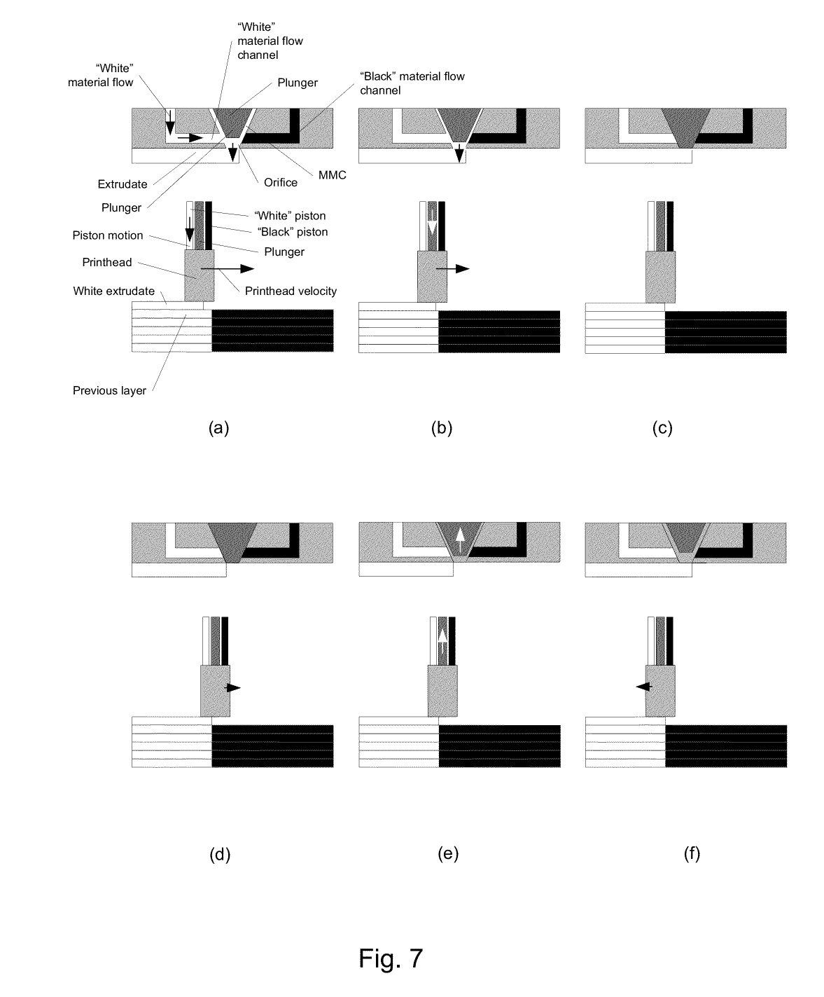

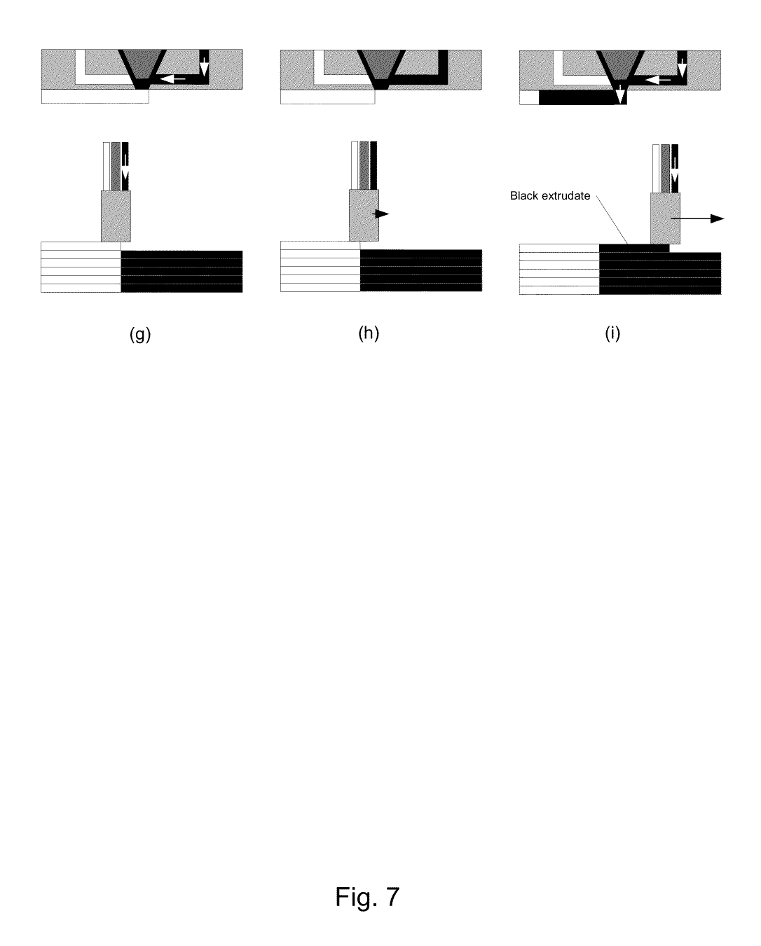

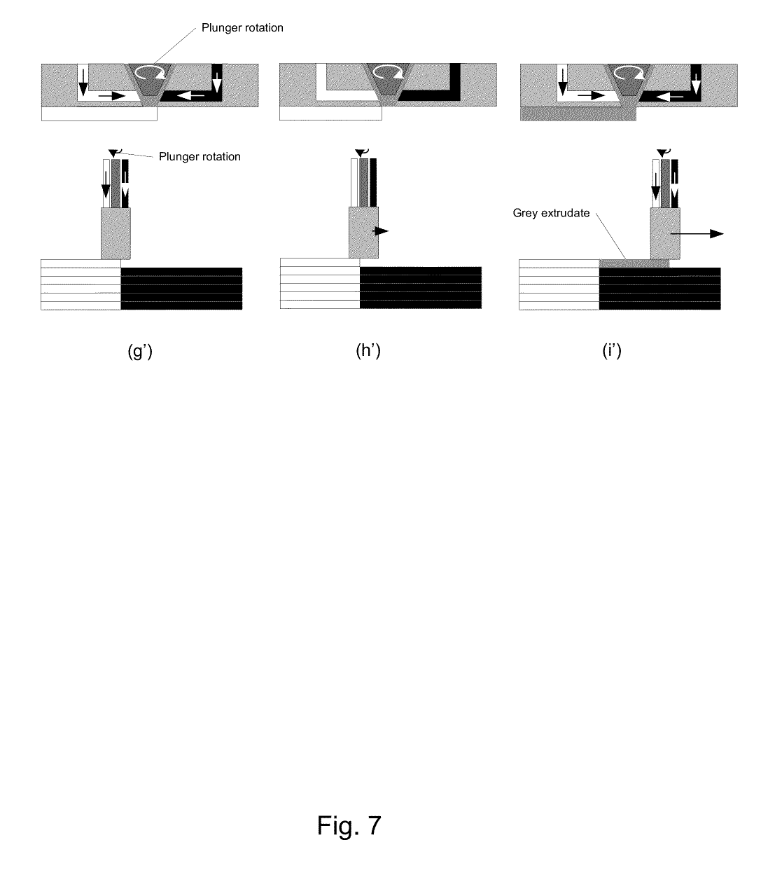

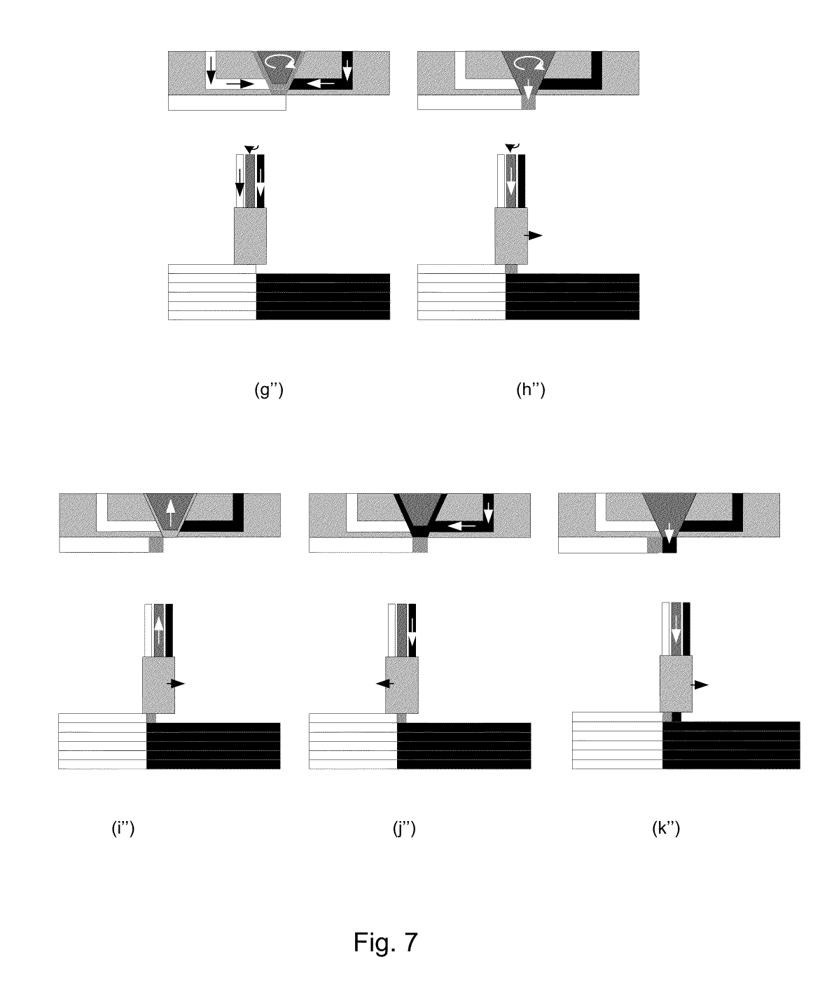

Several examples of methods of operation for the printhead will serve to clarify how a variety of extrudates, of both pure and mixed material, can be produced and used in the fabrication of a multi-material object. While a printhead of the kind shown in FIG. 6 or equivalent—with which non-thermoplastic materials are deposited—is assumed in these examples, the discussion applies equally to a printhead of the kind shown in FIG. 4 or other printheads through with which thermoplastic materials are deposited. In FIG. 7 (a-f) the printhead is dispensing long or short black and white extrudates, each comprising a single material fed into the printhead. The steps involved in obtaining an abrupt transition between white and black extrudate are depicted, both with magnified cross sections through the lower end of the printhead (upper images), and with an overview of the printhead and deposited material (lower images). While the motions shown in FIG. 7 are described as discrete, non-overlapping, and sudden, in some embodiments the motions may be overlapping, simultaneous, accelerate or decelerate, etc.

In FIG. 7(a), the printhead is moved via an actuator controlled by a control system along toolpaths that are determined based on the geometry (and in some cases, material composition) of the layer of the object to be fabricated. The motion is at normal velocity, and the printhead continuously extrudes white material while the white piston is advanced by an actuator controlled by the control system, forcing material to flow through the white channel. Meanwhile, the black piston is not actuated, and no black material is within the MMC. The plunger is preferably at the top of its travel, allowing white material to flow with minimal resistance into the MMC.

In FIG. 7(b), the control system—knowing the volume of the MMC (which may vary as a function of plunger position; however, this is also known) and anticipating (based on data representing the object to be fabricated, which has been processed ahead of time) an imminent need to transition abruptly to black material at an upcoming location—stops (or slows) advancing the white piston when there is enough material in the MMC to complete the white extrudate, and begins to lower the plunger using an actuator so as to begin to purge the MMC while (preferably) simultaneously completing the white extrudate. The control system in some embodiments may also reduce the printhead velocity as shown in the figure. In some embodiments, a multiple purge action (pulsing the plunger up and down) can be used to help ensure a clean break of the extrudate from the print head, which allows clean transitions and helps to eliminate stringers. As the plunger descends, in some embodiments it also cuts off flow of material into the MMC, since the flow channels connect to the sides of the MMC. In FIG. 7(c), purging of the MMC has been completed as the plunger displaces the material in the MMC. The last of the white material has been extruded, finishing off the white extrudate to its correct length. With the MMC substantially empty of white material, black material can next be introduced with minimal risk of intercontamination, allowing abrupt transitions between materials. In some embodiments, should there be any contaminated/intermixed material, it may be purged into a waste container or to the side of the fabricated object or in a location on the object where it is harmless (e.g., in the interior), be wiped by a wiper, etc. The printhead may in some embodiments be stationary at this point, as shown.

In some embodiments, the printhead is advanced slightly beyond the extrudate as shown in FIG. 7(d) if needed to allow solidification of the extrudate (e.g., for thermoset materials, allowing the extrudate to be heated as in FIG. 12, or for thermoplastic materials, moving to a position such that the heated orifice plate or nozzle is no longer in contact with the extrudate, and optionally pausing to allow solidification. Next, in some embodiments, the plunger is raised/retracted, e.g., to its uppermost position, as in FIG. 7(e). Since there is no unsolidified extrudate beneath the orifice, none can be drawn inadvertently into the MMC while the plunger rises. As the plunger rises, in some embodiments the volume of the MMC is filled with air entering the orifice, and the plunger rises slowly enough to allow for this. In other embodiments in which the plunger rises quickly, a partial, temporary vacuum may be formed in the MMC, which may be used to help introduce material into the MMC. In yet other embodiments, material may be advanced into the MMC as the plunger is raised, to minimize the formation of a vacuum and the force required to raise the plunger, and reduce any risk of possible deformation of the orifice.

In some embodiments the printhead is then reversed slightly so that the orifice is at least partially blocked by the now substantially solidified extrudate as in FIG. 7(f). This minimizes the risk of premature extrusion of the material that enters the MMC in the next step. Next, in some embodiments the black piston moves (or e.g., for thermoplastic materials, the black filament moves) forcing black material into the MMC as in FIG. 7(g). Then, the printhead is advanced slightly in some embodiments as in FIG. 7(h) to place the orifice in a position to begin the black extrudate. Lastly, as in FIG. 7(i), the piston is advanced causing extrusion of black material to occur continuously while the printhead moves forward at normal velocity. In some embodiments, extrusion of black material begins as material enters the MMC (i.e., in FIG. 7(g)). While the two extrudates (white and black) are shown to be contiguous, they may not be necessarily.

It is assumed in the figures that the plunger is not spinning since in FIGS. 7(a)-(f), no mixing of materials is required; however, to avoid delays in stopping and starting rotation, in some embodiments it may be spun continuously. The control system must of course anticipate changes in material and orchestrate adjustments to material feeds, printhead speeds, and plunger motion and rotation accordingly.

In combination with FIGS. 7(a-f), FIGS. 7(g′-i′) depicts an alternative to the steps shown in FIG. 7(g-i) wherein the material transitions not to pure black, but to a mixture of both white and black. In some embodiments in FIG. 7(g′) the plunger (if not already rotating) begins to spin, and both the white and black pistons are advanced—at a relative speed that provides the desired proportions and total volumetric extrusion rate—pushing both materials into the MMC; mixed “gray” material also starts to extrude from the orifice. Then the printhead is advanced slightly in some embodiments as in FIG. 7(h′) to place the orifice in a position to begin the grey extrudate. Then in some embodiments in FIG. 7(i′), the printhead moves at normal velocity, continuously extruding gray material having a specified mix ratio. While the printhead moves, the relative speeds of the two pistons may be changed, producing compositional gradients in the extrudate along the axis of printhead motion.

In addition to the extrusion of long or short extrudates of homogenous or gradually-varied materials illustrated in FIGS. 7(a-i) and 7(g′-i′), micro extrudates may in some embodiments also be selectively deposited in regions of the fabricated object by operating in a pulsed/purging mode. In this case, extrusion is stopped and the MMC is filled with the desired material (or set of materials at the desired mixing ratio). This is mixed if necessary, and the MMC is purged by lowering the plunger to produce a micro extrudate of a size typically determined by the volume of the MMC (in some embodiments this can vary according to the initial position of the plunger). Following this procedure, another micro extrudate of different composition may be deposited or continuous extrusion of a short or long extrudate may occur. The production of two successive micro extrudates in some embodiments is illustrated in FIGS. 7(g″-k″), which replace and extend FIGS. 7(g-i).

In FIG. 7(g″) the plunger(if not already rotating) begins to spin, and both the white and black pistons are advanced—by a relative distance that provides the desired proportions and total volume of the micro extrudate—pushing both materials into the MMC while in some embodiments the orifice is at least partially blocked by previously-extruded material. In FIG. 7(h″), the printhead in some embodiments advances slightly forward and then the plunger descends, ejecting the mixed gray micro extrudate with the specified mix ratio. In FIG. 7(i″) the printhead is in some embodiments advanced beyond the grey micro extrudate and then the plunger is raised to create a suitable volume in the MMC. As already described, advancing the printhead can avoid drawing extrudate into the MMC, and may allow the extrudate to solidify.

Since the next micro extrudate will be of pure black material, in some embodiments the plunger rotation may be stopped; however, the plunger may continue to spin if desired during this and the remaining steps. In FIG. 7(j″) the printhead is in some embodiments returned so that the orifice is over the extrudate, minimizing the risk of premature leakage/ejection while the MMC is filled with black material. In FIG. 7(k′), in some embodiments the head is advanced and then plunger is lowered to eject the black micro extrudate.

When continuously extruding micro extrudates, each of which may have a different composition, the printhead thus operates in a pulsed mode, with the plunger oscillating/reciprocating up and down and the printhead (in some embodiments) advancing (and in some embodiments, reversing its motion) intermittently. Each time the plunger descends, it shuts off flow into the MMC from both flow channels and ejects the contents of the MMC to both form a micro extrudate and to purge the MMC in preparation for the next cycle.

Fabrication of objects as described above need not necessarily be significantly slower than conventional FDM even when material composition is varied significantly throughout a part. This is for several reasons: 1) the printhead may operate in a continuous mode most of the time, slowing down or stopping only when abrupt material transitions are needed; 2) if needed, multiple MMCs, each with its own orifice or connected to a common orifice (e.g., through a “Y” channel) can be used. For example, two MMCs (with associated hardware) operating out of phase with respect to one another (i.e., alternating extrusion and mixing) can be used to increase the pulsed mode duty cycle to close to 100% and minimize pausing or stopping of printhead motion: while material is loaded into and mixed in one MMC, it is ejected by the other. As an example of throughput if only one MMC is used, consider a part made entirely of 160 nanolitre micro extrudates measuring 0.25 mm in height (layer thickness) and 0.8 mm in width and length (length measured parallel to printhead motion). Assuming 30 ms for mixing and 10 ms for ejection/purging, then 25 micro extrudates can be produced per second, for a linear deposition rate of 20 mm/sec, which is very reasonable.

Materials

Among the thermoplastic materials suitable for use with the methods and apparatus described herein are materials such as ABS, nylon, polylactic acid, high impact polystyrene, polycarbonate, polyphenylsulfone, ABS-polycarbonate blends, polyester, and blends thereof. Among the thermoset materials suitable for use are thermally-cured thermoset polymers such as silicones, thiol-enes, polyimides, urethanes, epoxies, and vulcanized rubbers, and blends thereof, and ultraviolet and visible light-, or electron-beam cured materials including UV-curable silicones and thiol-enes. Other materials can also be used, including those which solidify by evaporation, by reaction with surrounding material, which do not solidify without further processing (e.g., after the object is fabricated), or which remain in a non-solid form (e.g., a gel). Hydrogels and other materials of interest to tissue engineering and regenerative medicine, and living cells or materials containing cells may also be used with the process. Polymers containing small particulate or fibers and which obtain final properties such as increased strength or magnetic properties without further processing [Nikzad, 2011; Shofner, 2003] are also possible.

With regard to thermoset materials, silicone elastomers are among some of the most promising materials for AM. The synthesis and properties of silicones are well-established and their applications are widespread, including their use in molded elastomeric parts, coatings, controlled-release materials, water repellents, and biomedical scaffolds [Clarson et al., 2000]. They are also commonly used in implants and prosthetics since short -or long-term implantable grades are available which can be completely polymerized by heating.

The primary molecular repeat unit in a silicone is [—SiR2-O—], where R is an alkyl or aryl organic substituent. The flexibility of the Si—O—Si linkage is reflected in the low glass transition temperatures (Tg) of silicones, and the presence of hydrophobic R groups gives silicones their water repellent nature. The silicon atoms in each repeat unit also give silicones good thermooxidative stability. Silicones are readily cured by a platinum-catalyzed addition process. The cure is a two-component process in which one silicone possesses Si—H groups and the other possesses alkene groups bonded to silicon (i.e. Si—CH═CH2). Mixing the two components in the presence of a platinum catalyst initiates addition of Si—H groups to the silicon-alkene groups, resulting in crosslinking and cure. The properties of the cross-linked material can vary widely, and are easily controlled by a number of variables including molecular weight of the starting materials, concentration of reactive groups in the starting materials, and the identity of the other R groups on silicon. As a result, platinum-cured silicones are widely used as heat-curable rubbers and injection moldable products. In a similar fashion, silicones can be cured to thermosets via a UV-crosslinking process in the presence of a photoactive catalyst.

One general variety of silicone is known as liquid silicone rubber (LSR). LSR materials are optimized for use in injection molding, and are supplied as two components which are mixed prior to molding. Because of their rapid thermal curing and high degree of shear-thinning, they are well-suited for use in a material extrusion AM process. Moreover, silicone normally adheres well to already-cured silicone, a critical factor in building 3-D structures from multiple layers. In some embodiments adhesion promoters are added as needed. Examples of commercial LSRs are those made by NuSil Technology LLC (Carpinteria, Calif.), which are available in a wide range of durometers and have a long pot life and high purity/biocompatibility. For example, by feeding two miscible, compatible grades—MED-4905 (7 Shore A) and MED-4980 (80 Shore A) in the desired proportions into the printhead and mixing in the MMC, silicone objects whose hardness can be spatially modulated (i.e., locally varied) over the range of 7-80 Shore A can be fabricated. To provide colors (e.g., for anatomical models) color masterbatches can be incorporated. For example, feeding four differently-colored silicones based on white, cyan, magenta, and yellow masterbatches to the printhead in the right proportions would enable a very wide range of colors to be produced.

A newer cure technology than silicones involves thiol-ene chemistry: the addition of thiols (—SH) to alkenes (-CH═CH2). Because thiol-ene reactions are extremely fast, clean, high-yielding, and insensitive to air and water, they are classified as a “click” reaction [Hoyle and Bowman, 2010]. Thiol-ene chemistry has been used extensively for the synthesis of cross-linked networks from component mixtures of polythiols and polyalkenes [Hoyle et al., 2004]. The advantages of using thiol-ene chemistry in this regard are minimal shrinkage and stress (which often cause distortion in AM-produced parts), high monomer conversions (improving biocompatibility, among other benefits), and uniform crosslink density. Glass transition temperatures are normally very narrow, reflecting high crosslinking homogeneity. Thiol-enes are inexpensive and attractive for a growing number of applications. For example, they can have impact resistance and energy absorption superior to materials such as polyethylene-co-vinylacetate often used in protective equipment such as mouth guards [McNair et al., 2013]. They are also being evaluated as a potentially superior dental restoration material. Additionally, bioresorbable networks can be prepared by employing degradable thiols as recently described [Jennings and Son, 2013], and a thiol-based biodegradable hydrogel has been explored as a delivery vehicle for human bone morphogenic protein-2 [P. Mariner et al, 2012]. Using methods and apparatus described herein, patient-specific mouth guards, dental restorations, and other medical devices can be manufactured. Thiol-enes can also have very good machinability, which can be important for achieving exact tolerances in AM-produced parts. Thiol-enes can be combined to yield a very wide range of properties, and can have relatively low viscosity, enhancing mixing. Thiol-enes have generally two liabilities: an unpleasant odor and relatively short shelf life once mixed. These can be largely overcome through the use of material extrusion AM (in which the material is not exposed until extruded) and point-of-use reactive mixing.

Traditionally, thiol-ene networks are cured photochemically or thermally via a free-radical process. An ionic mechanism in which the addition process is catalyzed by small amounts of an organic amine or phosphine compound may also be used. Thiol-ene reactions proceeding via an ionic mechanism are often called thiol-Michael reactions. The benefits of this mechanism are that the addition/cure takes place at room temperature and the rate is controlled by the type of catalyst. Reaction completion times as short as a few seconds are possible. Exploiting this catalytic approach and adjusting the timing, it is possible to mix and rapidly extrude a thiol-ene and have it solidify as an extrudate without the need for thermal activation; this is not feasible without point-of-use mixing.

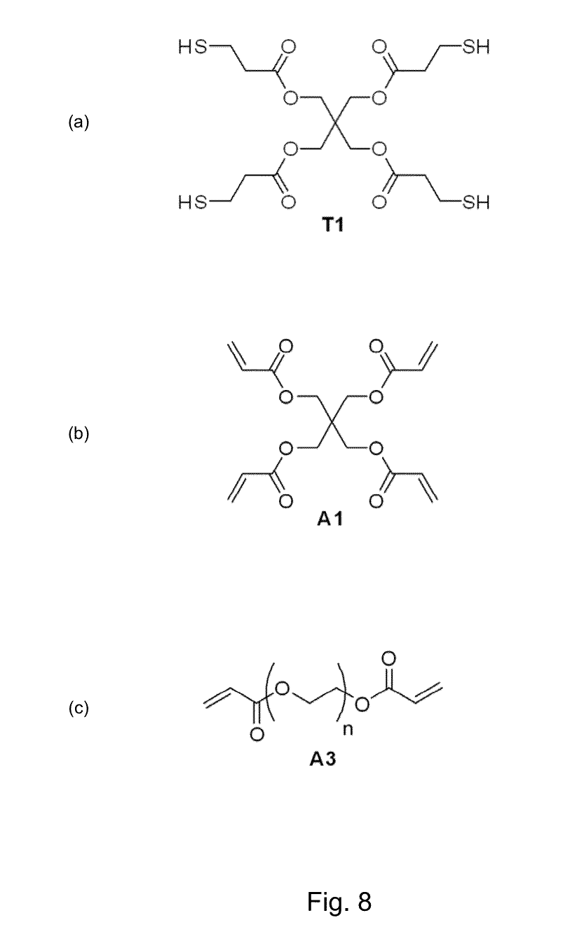

FIG. 8 depicts the chemical structure of some exemplary thiol and alkenes (enes), all of which are low viscosity liquids that will mix easily with one another. In any thiol-ene reaction, one thiol group (SH) reacts with one alkene group (==). Therefore, a given number of molecules of thiol T1 (FIG. 8(a)) requires the same number of molecules of A1 (FIG. 8(b)) for complete reaction, since both T1 and A1 contain the same number of reactive groups (four, in this case). By comparison, mixing T1 (tetrafunctional, with four active groups) with A3 (FIG. 8(c), difunctional, with two active groups) would require twice the quantity of A3 as T1. By decreasing the degree of functionality in the ene component, crosslink density will decrease. Generally speaking, reducing crosslink density results in decreased polymer hardness and elastic modulus. Therefore, a thiol-ene based on T1 and A1 will be harder and stiffer than one based on T1 and A3. Moreover, A3 can be obtained in a high molecular weight form that further reduces crosslink density, creating a large range of properties. By mixing a thiol-ene from T1, A1, and A3, for example (in a printhead that can handle three liquids), and smoothly varying the relative quantities of A1 and A3 (while maintaining the stoichiometry of reacting groups), properties of the mixed and extruded material can be varied. Indeed, while data available on material properties of thiol-enes is limited, a 10-fold change in the storage modulus has been obtained by changing the mixture ratio of some components tested [McNair et al., 2013] with three and two reactive groups. Using components with four and two reactive groups and further reducing crosslinking by using a high molecular weight ene enables a much broader range in material properties and can produce softer materials, for example. Such a crosslinking process can proceed via a photochemical or thermal free-radical mechanism or an ionic mechanism in the presence of a suitable catalyst such as an amine or phosphine.

Thermoset materials are often mixed before use from two or more separate components. For example, silicones are normally mixed from two components: one containing a catalyst and the other containing a crosslinker. If only one grade of silicone is to be deposited, then the two components can be separately fed to the MMC and mixed. In this scenario, the unmixed components can remain in the printhead and fluid delivery system for extended periods without harm. If, however, two or more different grades of silicone are to be mixed (e.g., to obtain a variable elastic modulus), then in some embodiments all components of all grades can be introduced into the printhead, while in other embodiments the components of each grade can be pre-mixed before loading, and only the pre-mixed materials need to be mixed in the MMC. This approach requires that unused, pre-mixed materials be cleaned out of the system before they spontaneously cure.

Thiol-enes can be cured after mixing two (or more) components, one of which is pre-mixed with a catalyst. These components can be fed to the printhead and mixed in the MMC. To spatially-modulate thiol-ene properties such as modulus, three or even four components can be metered into the MMC and mixed in variable ratios. The catalyst should be selected so that curing does not take place during mixing, but only upon ejection from the MMC and in some embodiments, after the addition of energy (e.g., heating). Alternatively, thiol-enes can be cured photochemically by exposure to UV radiation, typically in the presence of a photoinitiator catalyst.

Fluid Mechanics

An aspect of the subject matter described here is mixing of component materials, which in the case of some materials such as molten thermoplastics and silicones (though not typically thiol-enes) may be highly viscous. The blending time for the various materials must remain short so that overall machine throughput is reasonable. Moreover, the MMC volume must be small so that short micro extrudates may be formed, providing high spatial resolution in material composition. With some materials, perfect mixing is not required for good properties, but the better the mixing is, the more well-controlled the final material properties will be.

Although the scale of the mixing domain required is similar to many microfluidics applications, the mixing method proposed (high-speed plunger with a conical, spherical, or cylindrical geometry) differs substantially from those used in microfluidics devices because of the unique requirements of the printhead, including rapid purging of the volume and potentially high fluid viscosity (e.g., 100,000 times that of water). The vast majority of microfluidics mixers utilize long channels of various geometries to promote mixing [Nguyen and Wu, 2005; Capretto et al., 2011] which frequently require long residence times and a large mixing volume. Exceptions to this rule include vortex mixers [e.g., Lin et al., 2005; Long et al., 2009] and acoustic forcing [e.g., Ahmed, 2009]. However, vortex mixers work well only for Re ˜10-100 in water, which would require enormous flow rates to achieve for highly viscous materials and are thus not applicable for many polymers. The large viscosity of some of the materials to be mixed makes acoustic methods highly problematic. Rather, an approach using direct forcing with a mixing geometry that can be optimized for the desired mixing behavior is far more effective.

At a useful scale for the MMC (˜100 nanoliters), diffusion of species can take a minimum of minutes, making mixing by diffusion impractical. For this reason, forced/active convective mixing using a spinning plunger rotating at a high speed is used to promote mixing as rapidly as possible. As an example, consider a material with an effective viscosity of 100,000 cps at typical extrusion rates. For an MMC with a diameter of D ˜1.3 mm and a plunger of similar diameter spinning at 80,000 rpm, the Re of the mixing process is less than 0.04. Consequently, rapid fine scale mixing promoted by turbulence or even unsteady convective effects which appear at moderate Re (i.e., Re >100) are unavailable.

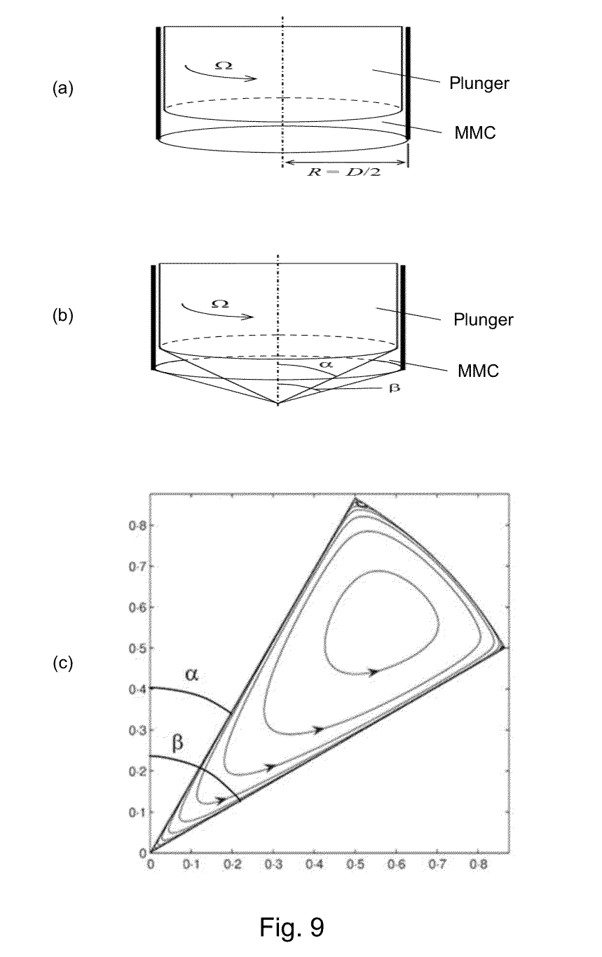

For the case of Re ˜0.01, mixing is determined directly by the motion of the plunger as it swirls the polymer components together though rotary motion. The simplest such arrangement is illustrated in FIG. 9(a), which illustrates a cylindrical MMC with the bottom surface fixed and the top surface rotating. For an anticipated residence time of 20-40 ms (e.g., in the pulsed mode of operation), the plunger will have rotated 27-53 times. This provides sufficient mixing of the fluid in contact with the plunger. However, the preferred geometry in this configuration is a short height, large diameter cylinder (to promote rapid mixing while minimizing volume) in which case the mixing will vary primarily linearly across the height of the MMC, with little mixing occurring at the bottom of the MMC for Re ˜0.01, though there may be some overturning of fluid and thus some top-to-bottom mixing as well. As a result, the level of mixing will tend to vary along the length of the extrudate rather than being sharply-defined, which can impede the curing process and disrupt the final material properties.

An approach to enhance mixing across the height of the MMC is to alter the geometry of the MMC in a way that promotes 3-D fluid motion to achieve overturning. One geometry that can accomplish this utilizes two cones with different half angles in which the inner cone spins to promote mixing, as shown in FIG. 9(b). In this case, the expanding geometry of the MMC with height (for α<β) promotes swirling motion in the meridional plane. FIG. 9(c) illustrates the streamlines in the meridional plane for one configuration of α and β defining the angles of two concentric cones at a particular rotation rate, as determined by the analytical and numerical analysis of Hall et al. [2007]. This theoretical work indicates that the 3-D vortical motion is much weaker than the driving motion and scales to order Re. For an Re on the order of 0.04, one can expect the fluid to overturn 1-2 times in the meridional plane for a residence time of 30 ms. While overturning more times will improve the mixing, overturning even once dramatically improves the overall mixing and provides nearly homogeneous extrudates. The results of Hall et al. [2007] show that the topology of the flow in the meridional plane is strongly dependent on the boundary geometry (α and β) and on the rotation rate (Ω), indicating that operating conditions may be tuned for optimizing mixing. In some embodiments, adding asymmetry to either the MMC or the plunger (e.g., adding to one of the cones a small recess or protrusion) results in more complex, 3-D streamline structures that promote increased 3-D mixing. In some embodiments the cones comprising the MMC have the same half angle (α=β) but are offset vertically; lowering the plunger can also completely purge the MMC. In some embodiments, oscillating the plunger along its longitudinal axis with appropriate amplitude and frequency may be used during mixing to provide more thorough and/or more rapid mixing.

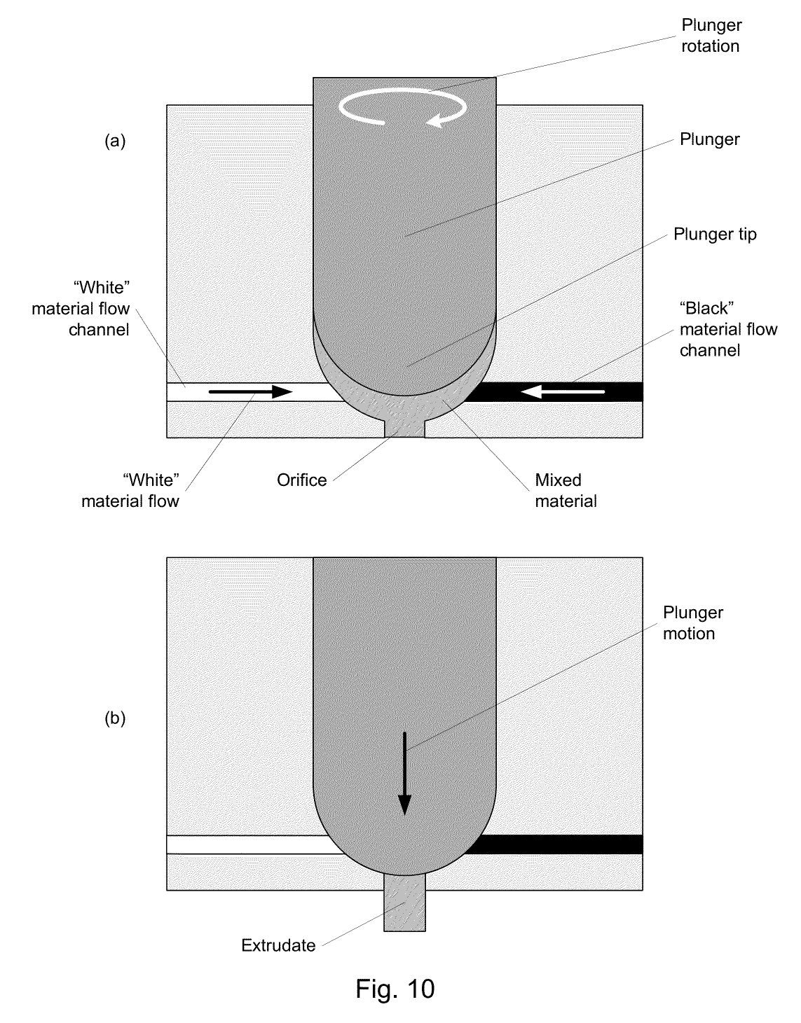

While using different cone angles promotes 3-D mixing, it makes complete purging by vertical translation of the plunger difficult. FIG. 10 depicts in cross sectional elevation view a printhead in some embodiments comprising an MMC shaped like a convex partial sphere (e.g., a hemisphere) and a plunger whose tip is shaped like a convex partial sphere (e.g., a hemisphere). When the plunger is raised as in FIG. 10(a), the cross-section of the MMC in the meridional plane is “half-moon” shaped. This shape is similar to the wedge shape illustrated in FIGS. 9(b-c), except that it is inverted (largest gap is on the bottom) and the walls are curved. Hence, it can promote mixing enhancement by overturning similar to that illustrated in FIG. 9(c) but also allows for complete purging of the MMC when the plunger is translated vertically to the bottom of the chamber (FIG. 10(b)). In some embodiments, the plunger tip and MMC can be provided with textures or features to enhance rapid blending, and preferably not interfere with complete purging. For example, one or more small protrusions on the plunger tip might fit into one or more cavities on the inner surface of the MMC (or vice-versa). When the plunger is raised, creating space within the MMC, the plunger can freely spin and the protrusions and/or cavities assist with mixing. When the plunger is lowered for purging, the protrusions can fit into the cavities, squeezing out any material that coats the protrusions or fills the cavities. In some embodiments the motor that rotates the plunger can have an associated encoder or other means for sensing its angle of rotation, thus allowing the plunger tip to be rotated so as to align the protrusions to their corresponding cavities before the plunger translates downward to purge the MMC. In other embodiments the plunger may be made free to rotate and the protrusions and/or cavities may be designed (e.g., with angled surfaces) to rotate the plunger passively as the protrusions enter the cavities.

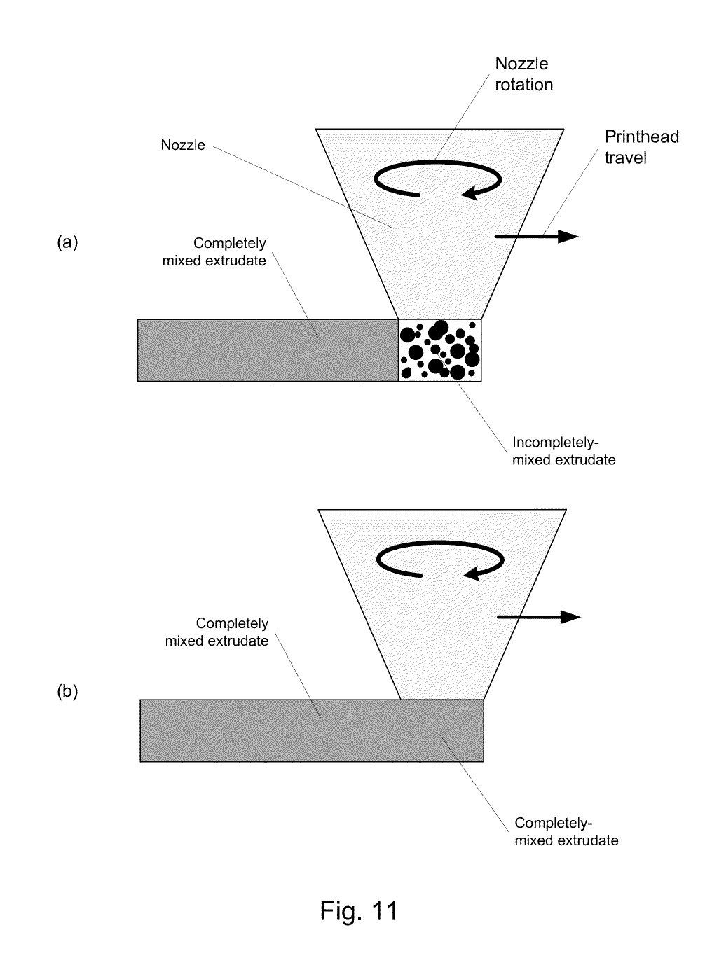

In some embodiments, material can be extruded from the orifice partially mixed or unmixed, with mixing occurring within the extrudate outside the printhead. For example, a rotating nozzle may be provided as in FIG. 11(a). Incompletely-mixed extrudate in contact with the nozzle (during and/or after extrusion) is mixed by the rotation motion (which in some embodiments also involves linear vibration along the axis of rotation and/or either or both axes perpendicular to it), yielding fully-mixed extrudate as in FIG. 11(b). For example, viscous drag on the extrudate due to contact with the bottom rotating and/or vibrating surface of the nozzle can substantially promote mixing. In some cases, the effective Re can be larger than for mixing within the nozzle if the characteristic length is larger once outside the confines of the nozzle interior. In some embodiment variations, textures or projections may be added to the nozzle tip to encourage mixing due to relative motion of tip and extrudate.

Metering and Mixing Ratios

As described, material is introduced into the MMC using a positive-displacement method such as a piston moving in a cylinder. In the case of thermoplastic materials, unmelted material serves as the piston. By using a relatively small diameter cylinder and a high-resolution drive, adequate metering control (e.g., <=30 nanoliters, or about 1/16 the volume of the MMC) can be provided. The minimum metering volume is preferably a small fraction of the MMC volume, since otherwise the number of possible mixing ratios can be relatively small since the volumes of all materials must sum to the MMC volume. For example, with two materials and a metering volume of 1/16 of the MMC, micro extrudates with 16 different mixing ratios (e.g., 16 different durometers) are possible. For longer extrudates, finely-graded mixing ratios can be provided by varying piston speeds.

Color and Support Material

A system for fabricating objects that are colored may use materials having at least four colors: white and the subtractive primaries cyan, magenta, and yellow. Black may be added in some embodiments to provide a better quality black than would be obtained by mixing all primaries. Opacity of these materials may vary from substantially transparent to substantially opaque, and in some embodiments additional materials may be added as opacifiers. Clear (i.e., uncolored) material may be added in some embodiments to create transparent regions of an object. To appear optically clear, regions of the final structure may be finished (e.g., sanding, polishing, reflow, chemical softening. The appearance of metal can be simulated by use of a clear resin that is filled with metal (e.g., Al) particles, similar to metallic paints.

In some embodiments support material (which supports structures during fabrication and is preferably soluble) may be delivered through the same printhead or a separate printhead. To enhance the strength of the mechanical connection between the fabricated object and the supports, especially in the case of materials such as silicone elastomers to which many materials do not adhere well, features may be provided in some embodiments on the fabricated object and/or supports which mechanically interlock the supports to the object. Such features may be designed in some embodiments so that they are hidden from view and/or do not interfere with the object's function. In some embodiments such features may be designed to be removed from the object. For example, the surface of a silicone object can include features with textures or undercut shapes such as those inspired by mushrooms or dovetail joints used in woodworking, such that these features are surrounded by the support during fabrication. Mechanical removal of the support may remove these features by tearing them loose, or they may be cut off, such as after the support is first removed by dissolution. The converse arrangement, in which the supports have undercut features surrounded by the object, may also be used in some embodiments, or a combination of both may be used.

Thermal Curing

In the case of thermoset materials, once the components are mixed (or if a single-component material, then without mixing), they often need to be cured using heat or light (e.g., ultraviolet). Thermal curing can be provided in some embodiments using an “extrude and cure” approach such as that shown in FIG. 12(a), in which extrudate is exposed to energy (e.g., thermal energy) shortly after leaving the orifice using light from a broadband IR (infrared) spot curing system (e.g., the iCure system of IR Photonics (Hamden, Conn.)) or a similar product by Full Spectrum Technologies (San Clemente, Calif.) or an IR system which illuminates over a broad area, including in some embodiments the entire layer. IR sources have already been used to quickly cure silicones [Huang et al., 1994; Reilly and Brunet, 2012], for example. In some embodiments, ultraviolet or visible-light cured thermoset materials such as silicone elastomers, acrylates, epoxies, and thiol-ene resins may also be used in conjunction with the methods and apparatus described herein, with light delivered to the material from a localized source (e.g., incandescent light, mercury bulb, or light emitting diode), through at least one light guide (e.g., optical fiber), through a laser, etc. Spot cure systems such as the BLUEWAVE® systems made by Dymax Corporation (Torrington, Conn.) exemplify suitable systems for UV curing using metal-halide bulbs or short wavelength LEDs, though flood curing may also be used.

In some embodiments the extrudate can be heated by a laser (e.g., a CO₂ laser producing infrared radiation) as in FIG. 12(b). In some embodiments, the wavelength(s) of infrared radiation whether delivered by a laser or not, are selected to penetrate through the thickness of the extrudate so that heating can be more uniform through the thickness of the extrudate. In some embodiments, non-infrared radiation may used, such as visible, microwave, and millimeter wave radiation. In some embodiment variations the laser is aimed not perpendicular to the layer as shown in FIG. 12(b), but at an angle so as to impinge on the extrudate closer to the axis of the orifice. In some embodiment variations multiple laser beams impinge on the extrudate; for example, a laser beam can be split and impinge on the extrudate from both sides of the extrudate, e.g., in a plane aligned with the orifice axis. In some embodiments the extrudate can be heated by a jet of hot gas (e.g., air) as in FIG. 12(c), such as can be delivered by the SMD Hot Air Pencil model ZT-2 made by Zephyrtronics (Pomona, Calif.). In some embodiment variations, more than one source or beam of infrared light, more than one laser or laser beam, or more than one jet of gas may be used. For example, in order to minimize possible motion of the material when the jet impinges on it, at least two opposing jets may be provided to balance the fluid forces on the deposited material. For all these methods, the location of the heating must be continuously adjusted as the printhead moves through a complex 2-D path, such that the heating is always applied downstream of the orifice. In some embodiments at least a portion of the thermal curing hardware can be rotated around the orifice axis, while in other embodiments the build platform holding the fabricated object can be rotated about an axis coincident with the orifice axis: this obviates the need to rotate the curing hardware.

In some embodiments the extrudate can be heated by contact with a heated, non-adherent (e.g., PTFE-coated) surface. The surface can be for example a plate adjacent to the printhead, or preferably, a ring as in FIG. 12(d) which surrounds it and performs omnidirectionally such that no matter which way the printhead moves, the extrudate can be heated and cured. The plate or ring is preferably separate from, or at least thermally insulated from, the printhead, such that unheated material entering the printhead won't be prematurely heated by the plate/ring; moreover, it may be coated with a non-stick material such as Teflon®. Similarly, hot gas may be delivered through a ring-shaped slot in a manifold surrounding the orifice or a ring-shaped radiant heater surrounding the orifice may be used, curing the material regardless of the direction of the printhead at any moment in time.

Whatever the approach, the material must be heated rapidly and the heating sustained long enough for the material to cure at least partly (curing can be completed after the object is at least partially formed using an oven or other heat source if necessary), establishing adequate mechanical strength, given the geometry, the supports provided, etc. Thus, material requirements, thermal power density, size of the heated zone, and printhead velocity must all be considered and optimized for a particular layer thickness. In some embodiments, layer thickness is minimized as much as possible to speed curing. In some embodiments, curing is done at the highest possible temperature that does not produce damage to the material or a change in properties. In some embodiments, the thermal conductivity of the material is enhanced through the addition of fillers (e.g., in the form of fine powders). For example, boron nitride (BN), available in powder from such companies as ZYP Coatings, Inc. (Oak Ridge, Tenn.), has a dramatically high thermal conductivity than polydimethylsiloxane (PDMS), so incorporating BN powder in a significant volume fraction into PDMS and similar materials such as LSRs can significantly accelerate curing.

A typical FDM toolpath is typically based on a vector (vs. a raster) approach and may involve first depositing “contours” of the layer along the boundaries of the layer geometry, and then filling in the inside of those contours with additional extruded material (e.g., in parallel lines) as “fill”. This, however, involves large, fast movements of the printhead. In some embodiments, in order to expose the extruded material for a longer time to a heating source that is localized (e.g., laser, gas jet, heated surface) the toolpaths for printhead motions may be arranged so as to keep the printhead depositing material in a localized region of the layer as long as possible without significantly reducing productivity of the fabrication process. For example the printhead may deposit extrudates for both contours and fill in a small area (e.g., 10×10 mm), all the time allowing the material time to thermally cure at least to an extent that provides mechanical stability, and then move on to form contours and fill in other areas. In some embodiment variations, these areas overlap, such that the printhead moves in a progressive fashion across the layer, and all material is exposed to heat for approximately the same time, or for at least a minimum time.

In some embodiments, material may be deposited in a raster approach using a single or multiple orifices, defining the layer geometry using a set of parallel extrudates (which may be oriented differently from layer to layer). In such embodiments, heating of the material can be performed in a progressive fashion with heating means which cover a width sufficient to span the extrudates (e.g., a wide heated surface, a heated gas jet issuing from a slot) to provide heating over an extended period of time as the layer progresses. In some embodiments, if the material has reasonable mechanical stability—and especially if it is well supported—partial, complete, or additional curing can be provided by a heated roller which passes over the layer. In the case of a vector approach, this may be done after some of the layer is formed, or after all of the layer is formed. In the case of a raster approach, in some embodiment variations the roller may follow the printhead as it moves from one edge of the printed area to the opposite edge, delivering heat as it moves. In some embodiment variations, material may be deposited and then the deposited material is placed in contact with a heated surface covering a large area (e.g., the entire printed area, or a portion thereof). This can be achieved, for example, by moving the printhead out of the way and lowering a heated surface onto the layer, or raising the object to contact the surface.

Control System

The control of the apparatus and the implementation of the methods and steps described herein may be achieved using hardware, software, or any combination thereof, together forming a control system. The term “hardware” may refer to either one or more general or special purpose computers; microcontrollers; microprocessors; embedded controllers; or other types of processor, any of which may be provided with a memory capability such as static or dynamic RAM (random access memory); non-volatile memory such as ROM (read only memory); EPROM (erasable programmable read only memory), or flash memory; magnetic memory such as a hard drive; optical storage media such as CD (compact disc) or DVD (digital versatile disc); etc. The term may also refer to a PAL (programmable array logic) device, an ASIC (application specific integrated circuit), an FPGA (field programmable gate array), or to any device capable of processing and manipulating electronic signals.

The term “software” may refer to a program held in memory, loaded from a mass storage device, firmware, and so forth. The program may be created using a programming language such as C, C#, C++, Java, or any other programming language, including structured, procedural, and object oriented programming languages; assembly language; hardware description language; and machine language, some of which may be compiled or interpreted and use in conjunction with said hardware.

The control system may serve to load files, perform calculations, output files, control actuators such as motors, voice coils, solenoids, fans, and heaters, and acquire data from sensors, to automate or semi-automate apparatus which can implement the methods and steps described herein. Each method described herein, including any sequential steps that may be taken for the method's implementation and any modification of the behavior of the apparatus or control system as a result of human or sensor input, as well as combinations of such methods, may be implemented and performed by the control system, executing a program, or code, embodied in the control system. In some embodiments, multiple control systems may be employed, and portions of the functionality of the control system may be distributed across multiple pieces of hardware and/or software, or combined into a single piece of hardware running a single piece of software.

Bath-Based Processes

As one alternative to “extrude and cure” approaches to thermoset AM described above, AM of thermoset materials such as silicone may be performed in some embodiments using a process similar to stereolithography (U.S. Pat. No. 4,575,330) in which the material to be cured is in a vat, but is cured thermally instead of by exposure to light (e.g., UV) energy, as in standard stereolithography. For example, in lieu of a UV laser, a laser (e.g., carbon dioxide, Nd: YAG, fiber) providing thermal energy at a suitable wavelength can be used to cure the material. Alternatively, thermal energy from an incoherent infrared source (e.g., quart halogen lamp) may be delivered to the liquid surface using suitable focusing optics, an optical fiber, etc.

As another alternative suitable for two-component thermoset materials, in some embodiments one component may be deposited within another as in the Fripp application number PCTlGB2014/053190 cited above, but with certain improvements to address problems with the disclosed invention. Specifically, mixing of the two components can be greatly enhanced, providing better mixing and a faster reaction, by spinning the nozzle tip or the entire nozzle about its axis so as to locally agitate and mix the two components. Rotation may also be used to alter the cured width of the material as the needle moves through the liquid in the bath. To reduce dependence on supports, material buoyancy can be better regulated by controlling the temperature of the bath and/or by localized heating or cooling of the nozzle.

General

It will be understood that particular embodiments described herein are shown by way of illustration and not as limitations of the disclosed subject matter. The principal features of the disclosed subject matter can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of the disclosed subject matter and are covered by the claims.

All publications and patent applications mentioned in the specification are indicative of the level of skill of those skilled in the art to which the disclosed subject matter pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof' is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. In certain embodiments, the present disclosure may also include methods and compositions in which the transition phrase “consisting essentially of” or “consisting of may also be used.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosed subject matter. All such similar substitutes and modifications apparent to those skilled in the art are deemed to be within the spirit, scope and concept of the disclosed subject matter as defined by the appended claims.

Applications:

Embodiments of the disclosed subject matter may enable or facilitate a wide range of applications including the following:

Rapid, cost-effective custom fabrication of products such as patient-customized long-term implants, prosthetics, and orthotics made from strong, affordable, off-the-shelf materials such as pure, medical-grade silicones. Implants and prosthetics may be used for soft tissue replacement, for example. Applications include ophthalmic, vocal fold, finger joint, and reconstructive implants (e.g., leak-free, lightweight breast implants for mastectomy patients), hydrocephalus shunts, heart valves, intraocular lenses, as well as nose, ear, and finger prosthetics (e.g., for accident victims or to correct anatomical deformities). The ability to vary elastic modulus to provide the right stiffness in the right locations is useful for achieving life-like behavior, especially since many living structures have variable (e.g., graded) material properties that help them function (e.g., hard where stiffness is required, soft where toughness is needed). Anatomically-specific wound healing dressings and devices, and patient-customized dental bleaching trays and bite guards, e.g., printed based on intra oral scan data, are among other applications.

Elastomeric products can also be made from single and multiple materials such as patient-customized orthotics and goggles; and face masks, and respirators for divers, fighter pilots, CPAP (continuous positive airway pressure) patients, and people working with hazardous materials. Earplugs, earbuds, and hearing aid shells that are individually customized are among other objects that may be made.

There is a need for anatomically accurate, realistic models of human tissue and organs for purposes of medical training, device development, and pre-surgical planning, e.g., as an affordable and available alternative to cadaveric tissue. The disclosed subject matter can be used to produce models simulating the elastic modulus (and ideally, color) of actual tissue, e.g., based on CT, MRI, or ultrasound scans of individual patients.

Catheters used in interventional medical procedures typically vary in hardness from proximal to distal end, and must be fabricated through a laborious process of separately extruding and joining multiple sections of tubing. With the proposed process, these could be produced monolithically, and if desired be tailored to a patient's unique anatomy.

The ability to precisely mix and print multiple fluids can benefit bioprinting of tissue and tissue scaffolds, for example, polymer scaffolds having built-in chemical gradients that promote/direct tissue growth.

Implants (e.g., silicone) or other medical devices which elute drugs in a controlled fashion can be fabricated using the methods and apparatus described herein. Drugs that can be delivered using silicone (polydimethyl siloxane), for example, include antiviral compounds, antibiotics, antidepressants, antiangiogenics, anxiolytics, vitamins, antifungals, antiviral compounds, and opioid and nonopioid analgesics. For example, age-related macular degeneration (AMD) can be treated using a drug-eluting episcleral device (e.g., approximately disk-like in shape) made using medical-grade silicone, in which the drug (e.g., an anti-angiogenic) is mixed with silicone before it is cured. The ability to fabricate an implant using AM by itself allows the customization of geometry to the patient: matching the curvature of the device to the curvature of the eyeball to achieve intimate contact and better resistance to migration, adjusting the size and thickness to anatomical constraints and to the volume and type of drug to be delivered, providing porosity to encourage integration with tissue, etc. Furthermore, AM enables complex geometry in the device, such as fixation and anchoring structures including microscale suction cups and rings and micro-Velcro®-like structures which achieve improved adhesion to eye tissue; internal cavities to contain drug in liquid, solid, or gel form (e.g., serpentine channels, reservoirs); and so forth.

Moreover, by also being able to modulate the composition of the device locally, additional functionality can be provided. For example, by adjusting drug concentration on a voxel-by-voxel basis, release rate and directionality can be controlled, and multiple drugs can be incorporated in the same device, each with its own distribution profile, release kinetics, and directionality. Portions of the device which contain drugs may be given customized geometries which influence the rate and directionality of drug release. Some portions of the device can be made to contain and elute drug, while others can be passive, serving as diffusion barriers that control the timing and directionality of drug release. For example, the surface of the device facing away from the sclera, as well as the edges of the device, can be fabricated with one or more diffusion barriers. The permeability of the device to the drug may be altered by formulation (e.g., mixing different grades of silicone, mixing silicone with other materials such as poly(methyl methacrylate) or with fillers, or introducing gas bubbles into the silicone). Thus, some voxels may be formed with a high permeability to maximize drug elution through them, while other voxels (e.g., those intended as diffusion barriers) may be formed with a low-permeability material. Mixing of grades or materials may also be used to vary elastic modulus locally, helping the device better conform to tissue, etc. In general, simply being able to encapsulate one material with another can enable a number of drug delivery devices.

Scleral implants may require a smooth, concave compound curvature on the side in contact with the sclera. It is normally challenging due to layer stairsteps to additively manufacture a curved object with a complex curvature (e.g., hemispherical) having a smooth surface. However, the device can be fabricated in a flat configuration, but with residual stresses built in which are tailored to distort it into the required shape after fabrication is complete. Alternatively, the device can be fabricated using curved layers; e.g., a hemispherical surface fabricated using a 3-D spiral extrusion toolpath in which the nozzle can move simultaneously along the X, Y, and Z axes as it extrudes material. Such approaches may also be adapted to create optical elements such as intraocular lenses and contact lenses.

Drug-delivery devices may be made from materials which allow post-adjustment after implantation. For example, magnetic materials incorporated into a device using methods and apparatus such as those described herein can allow for the rate and/or direction of drug elution to be adjusted from a distance using magnetic forces which act on the implant. Drug delivery devices may also incorporate sensors to indicate their status or report on physiological conditions.

Capabilities and approaches described herein (e.g., fabricating drug delivery implants for the eye or for other medical indications) and enabled by the methods and apparatus of the disclosed subject matter may also be applied to other medical devices including instruments and implants.

The micro-blending ability provided by the methods and apparatus disclosed herein can also be extended to making composite materials such as those which comprise a continuous matrix (e.g., polymer) with a filler (e.g., a metal, ceramic, or polymer powder or microscale fiber). By pre-blending liquid binders with ceramic or metal powders, FDM has been used to print and then thermally process structures to create functional parts [Vaidyanathan et al., 2009]. Likewise, with particulate-filled polymers it is possible to fabricate structures which include thermally and electrically conductive, radiopaque, and even magnetic regions (e.g., using NdFeB powders [Xiao, 2000] such as those sold by Magnequench (Science Park II, Singapore), or strontium ferrite powders such as those made by Hoosier Magnetics (Ogdensburg, N.Y.)), or particles or fibers which enhance mechanical properties. Appropriate modification of the proposed micro-blending process also allows locally varying the filler concentration to yield parts with abrupt interfaces between volumes with disparate properties or functionally graded parts. Applications for graded parts include orthopedic implants, sporting goods, and advanced armor.

Soft robotics—a rapidly-emerging field—commonly use hydraulic or pneumatic actuators. The ability to print robot components with locally-tailored elastic modulus facilitates actuation, e.g., using a relatively soft elastomer for an actuator based on expanding bladder, and an elastomer or other material with relatively high modulus of elasticity as a rigid “skeleton” element or fluidic conduit. Similarly, relatively stiff materials used for supports may be, if soluble during a support removal process, encapsulated by soft materials and thus serve as internal skeletons for a fabricated object.

Clothing and accessories such as wet suits, shoes, and jewelry; wearable electronic devices, and microfluidic devices (e.g., for lab-on-a-chip or chemical reactors), may also be made.

Tactile displays and haptic feedback devices may be produced.

Monolithically-fabricated fluidic devices such as pumps and valves may be produced.

Objects with spatially-varied properties (such as elastic modulus) modulus) may be produced which exhibit metamaterial properties such as diverting or dissipating impact (e.g., for a protective helmet application), modifying the propagation of energy (e.g., light, sound, vibration, heat), etc.

Vibration isolation devices, including those which behave anisotropically, may be produced.

Testable prototypes of rubber products that will be molded in production such as seals, gaskets, valves, electrical connectors, and O-rings can be produced.

Colored models and prototypes may be produced for use in product development, architecture, and medical/scientific data visualization, topographical maps, etc. Moreover, the methods and apparatus disclosed herein when combined coupled with 3-D scanners known to the art may be used for full-color and/or multi-material 3-D facsimile systems.

Tooling for molding (e.g., injection molding, blow molding, casting) of thermoplastic materials such as ABS, thermoplastic elastomer, wax, and low melting point alloys, and thermoset materials such as urethanes may be rapidly fabricated using methods and apparatus described herein. Cooking tools, bakeware, and molds (e.g., made from silicone elastomer) may also be produced.

Optical elements such as standard lenses (e.g., intra-ocular and contact lenses for medical use) or gradient-index lenses can be manufactured. Surfaces with “stair step” or other artifacts can be smoothed by reflow (e.g., using surface tension or contact with a smooth mold).

Multi-material and/or full-color prototypes and end-use products can be produced from desirable engineering polymers such as thermoplastics and thermosets. For example, more realistic and useful prototypes can be made of products which in full-scale manufacturing will be made from multiple parts, each with its own material properties, or made using two-shot molding or similar methods. Benefits of producing products using fewer parts include cost reduction due to relaxed tolerances, reduced assembly labor, and reduced inventory costs.

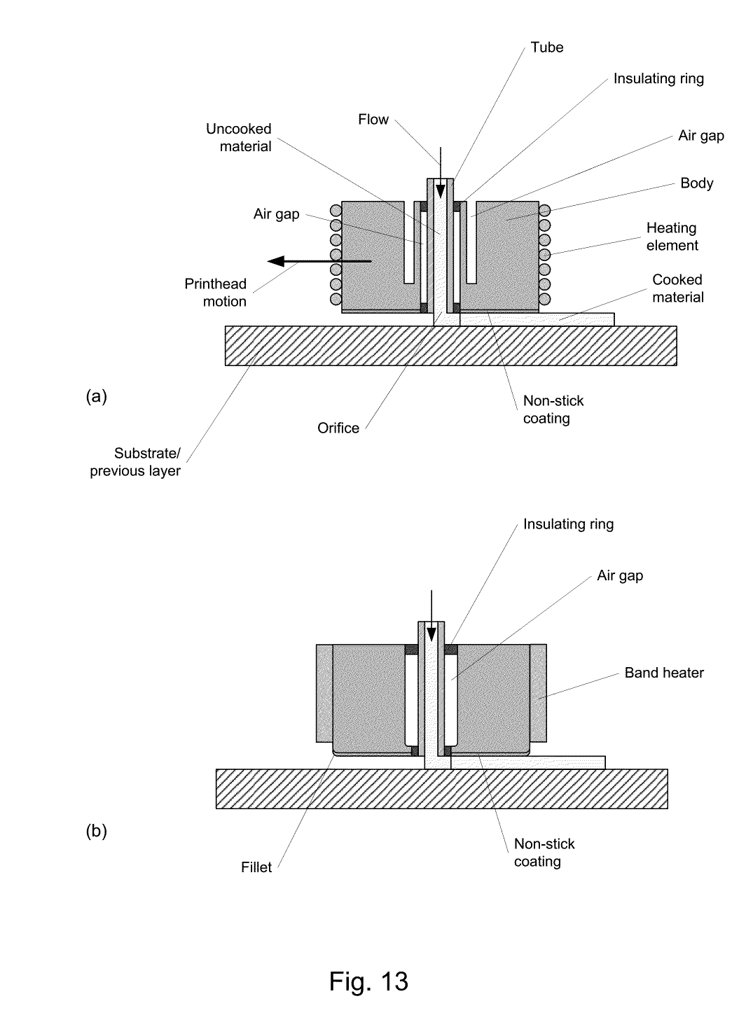

The apparatus and methods described herein are applicable to the preparation of foods. For example, to produce foods using AM one may wish to deposit different ingredients and mixtures thereof at different spatial locations, achieving abrupt transitions between them, or produce gradients in flavor, smell, texture, color, etc. Moreover, certain foods can be transformed by heating (e.g., by denaturing proteins). For example, the apparatus and methods described herein can be used to 3-D print a structure made from egg or an egg-containing mixture such as a batter by extruding the egg or mixture and subjecting it to heat as it extrudes. FIG. 13 depicts a printhead for an AM system which can be used to simultaneously deposit and cook a liquid (or in some embodiments deposit and thermally cure a liquid thermoset, etc.), and with some similarities to the printhead and heated ring of FIG. 12(d). Such an AM system can fabricate, for example, various foods which contain ingredients which solidify or rigidify upon exposure to heat such as those containing proteins which denature (e.g., egg, animal muscle). Thus omelets, baked goods, and meats, for example may be cooked with complex 3-D shapes. Two exemplary variations of the printhead are shown in FIGS. 13(a) and (b); a suitable printhead may incorporate elements from one or both of these, and/or other elements. In both variations, uncooked material enters (e.g., via gravity, pressurized by a pump) through a tube that is surrounded by an insulator (e.g., an air (or vacuum) gap as shown, a thermally stable insulating material (e.g., PTFE), aerogel, etc.). The insulator serves to isolate the material from the heated body of the printhead. If an air or vacuum is provided, insulating rings are provided to support the tube within the body of the printhead. The body of the printhead is preferably of a highly thermally conductive material such as aluminum or copper and may be heated by a heating element such as a cartridge heater (not shown), a heating cord wrapped around it (FIG. 13(a)) or a band heater surrounding it (FIG. 13(b)). The underside of the body, serving the function of the heated ring in FIG. 12(d), may be coated with a non-stick coating on its underside, such as PTFE and/or a cooking oil, to minimize adhesion to the body. In some embodiments, the liquid may contain non-stick additives such as cooking oil. The bottom edge of the body may be filleted as in FIG. 13(b) to help break any adhesion of the cooked material. As uncooked material reaches the bottom edge of the tube and extrudes out through the orifice of the tube (which may have a different (e.g., smaller) diameter than the tube inside diameter), the printhead moves forward, causing liquid to come into contact with the lower surface of the printhead body. Since the printhead preferably moves with a reasonable speed (e.g., 10-100 mm/sec), the temperature of the lower surface may be made much greater than that of typical cooking surface such as a frying pan or griddle, minimizing the available cooking time.

The ability to fabricate anisotropic objects by selectively incorporating multiple materials can be used to compensate for anisotropic properties exhibited by objects fabricated from a single material, making the object more isotropic. The ability to fabricate inhomogeneous objects by selectively incorporating multiple materials can be used to compensate for inhomogeneous properties exhibited by objects fabricated from a single material, making the object more homogeneous.

Objects fabricated according to the methods and apparatus described herein may be designed to behave in complex ways (e.g., deform into certain shapes when stressed).

By integrating the disclosed subject matter with the subject matter described in co-pending non-provisional U.S. patent applications 14/213,908 and 14/213,136, the applicability of the latter applications can be extended. For example, using thermoset materials according to the disclosed subject matter it would be possible to additively manufacture actuators that can withstand higher currents without softening; fabricate custom or complex heaters (e.g., from silicone) with embedded resistive (e.g., Ni—Cr) wires; print circuit boards (or 3-D versions thereof) which can better tolerate the heat of soldering; provide junctions between wire with solders with higher melting points; fabricate pacemaker and implanted cardioverter defibrillator leads and neurostimulation electrodes (e.g., for deep brain stimulation, vagus nerve stimulation, peripheral motor nerve stimulation, and cochlear implants) having many channels—now very challenging to make—from long-term implantable materials such as silicone and Pt-Ir wire; produce soft robotic components in which the local hardness is varied to achieve more complex motions, create bone-like rigid elements, etc.; and create composite materials using thermoset resins along with glass fiber, carbon fiber, or Kevlar as embedded reinforcing fibers.

Ramifications:

In some embodiments, objects may be built from only a single thermoset material, using thermoset curing methods and apparatus described herein. In some embodiments, objects may be built from multiple materials which are deposited individually without inter-mixing.

In some embodiments, objects may be built using an approach analogous to halftone printing in which multiple materials aren't mixed. Rather, they are deposited in small volumes and these volumes (e.g., of two or three different materials) are interleaved in one, two, or three dimensions to form a material having an average, integrated behavior that is determined by the materials that comprise it. The volumes may be as small as single voxels (with each voxel having the minimum possible volume of deposited material) or may include cluster of voxels. For example, suppose two compatible and mutually adherent materials M and N with different elastic moduli EM and EN, respectively, are deposited as single cubic voxels measuring 500 μm on a side, interleaved in X, Y, and Z to form a 3-D checkerboard-like pattern. The average modulus of the material EA would then be halfway between the values of EM and EN. If on the other hand, the material comprised more voxels of material M than of material N (e.g., material M voxels in a cluster) EA would be closer to EM than to EN.

The use of multiple materials and/or colors readily allows objects to incorporate many design features such as labels, logos, textures, and bitmap images.

Not all polymers can be blended and not all can adhere well to others, though through the use of tie resins such as ADMERTM or TYMAXTM otherwise-non-adherent resins may be combined.

The methods and apparatus described herein may be applied to fabrication of objects using ceramics or metals (similar to ceramic and metal injection molding) as well as polymers. For example, green ceramic structures comprising ceramic powder(s) and binder(s) in which the composition is spatially modulated can be fabricated; these may then be fired if needed to obtain the final properties. Piezoelectric devices such as ultrasonic transducers, electronic substrates similar to LTCC (low temperature co-fired ceramic) or HTCC (high temperature co-fired ceramic) substrates with built-in metallization and passive components, magnets, and orthopedic implants are among possible applications. Metal parts comprising multiple types of metal particles and/or multiple binders may be produced, producing for example hard metal surfaces for wear resistance with soft interior volumes for impact resistance. Molten metals may also be mixed and variably alloyed using methods and apparatus similar to those described here. In general, heterogeneous objects can be produced in which the general type of material (e.g., ceramic, metal, thermoplastic polymer, thermoset polymer, living cell) as well as the particular properties of material (e.g., durometer, color) is spatially varied in abrupt or continuous fashion.

### REFERENCES

D. Ahmed, X. Mao, J. Shi, B. Juluri, and T. Huang (2009) A millisecond micromixer via single-bubble-based acoustic streaming. Lab Chip, 9, 2738-2741.

I. Barker, M. Ablett, H. Gilbert, S. Leigh, J. Covington, J. Hoyland, S. Richardson, and A. Dove (2013) A microstereolithography resin based on thiol-ene chemistry: towards biocompatible 3D extracellular constructs for tissue engineering, Biomat. Sci. 18 December.

H. Boyer, A. Douglas, and N. Pettis (2014) Build material switching, U.S. patent application # 2014/0034214.

L. Capretto, W. Cheng, M. Hill, and X. Zhang (2011) Micromixing within microfluidic devices. Top. Curr. Chem., 304, 27-68.

S. Clarson, S. Fitzgerald, M. Own, and S. Smith, eds. (2000) Silicones and Silicone-Modified Materials American Chemical Society, Washington, D.C.

I. Grida and J. Evans (2003) Extrusion freeforming of ceramics through fine nozzles. Journal of the European Ceramic Society, 23, 629-635.

O. Hall, C. Hills, and A. Gilbert (2007) Slow flow between concentric cones. Q. Jl. Mech. Appl. Math, 60, 27-48.

O. Hall, C. Hills, and A. Gilbert (2009) Nonaxisymmetric stokes flow between concentric cones. Q. Jl. Mech. Appl. Math, 62 132-148.

J. Hardin , T. Ober , A. Valentine, and J. Lewis (2015) Microfluidic Printheads for Multimaterial 3D Printing of Viscoelastic Inks [0001] Advanced Materials 27: 3279-3284.C. Hoyle, T. Lee, and T. Roper (2004) Thiol-enes: Chemistry of the past with promise for the future, J. Polym. Sci., Pt. A Polym. Chem. 42, 5301-5338.

C. Hoyle and C. Bowman (2010), Thiol-Ene Click Chemistry, Angew. Chem. Int. Ed. Engl. 2010, 49, 1540-1573.

T.-W. Huang, J.-H. Tsai, C.-P. Cherng, and J.-K. Chen (1994) Silicone rubber curing by high intensity infrared radiation, AIP Conference, Kansas City, Mo., American Institute of Physics Conf. Proc. 316, 305.

A. Jennings and D. Son (2013) Multifunctional thiols from the highly selective reaction of mercaptoalcohols with chlorosilanes, Chem. Commun. 49, 3467-3469.

J. Lewis, J. Smay, J. Stuecker, and J. Cesarano III (2006) Direct Ink Writing of Three-Dimensional Ceramic Structures, J. Am. Ceram. Soc., 89, 3599-3609.

C.-H. Lin, C.-H. Tsai, and L.-M. Fu (2005) A rapid three-dimensional vortex micromixer utilizing self-rotation effects under low Reynolds number conditions. J. Micromech. Microeng., 15, 935-943.

A. Li, A. Thornton, B. Deuser, J. Watts, M. Leu, G. Hilmas, and R. Landers (2012) Freeze-form extrusion fabrication of functionally graded material composites using zirconium carbide and tungsten. Solid Freeform Fabrication Symposium Proceedings, The University of Texas Press, Austin, 467-479.

M. Long, M. Sprague, A. Grimes, B. Rich, and M Khine (2009) A simple three-dimensional vortex micromixer. Appl. Phys. Lett., 94, 133501 (3 pp.).

P. Mariner, J. Wudel, D. Miller, E. Genova, S. Streubel, and K. Anseth (2012). Synthetic hydrogel scaffold is an effective vehicle for delivery of INFUSE (rhBMP2) to critical-sized calvaria bone defects in rats. J Orthop Res. 2013 March; 31(3), 401-406.

O. McNair, B. Sparks, A. Janisse, D. Brent, D. Patton, and D. Savin (2013) Highly Tunable Thiol—Ene Networks via Dual Thiol Addition, Macromolecules 46, 5614-5621.

T. McNulty, F. Mohammadi, A. Bandyopadhyay, D. Shanefield, S. Danforth, and A. Safari, (1998) Development of a binder formulation for fused deposition of ceramics, Rapid Prototyping Journal, 4, 144-150.

N.-T. Nguyen and Z. Wu (2005) Micromixers—a review. J. Micromech. Microeng., 15, R1-R16.

N. Oxman (2011, #1) Methods and apparatus for variable property rapid prototyping, U.S. Patent Application # 2011/0079936 A1 .

N. Oxman (2011, #2) Variable property rapid prototyping. Virtual and Physical Prototyping, 6:1, 3-31.

C. Pax (2014) Color switching for three-dimensional printing, U.S. Patent Application # 2014/0070461.

D. Periard, E. Malone, and H. Lipson (2007) Printing Embedded Circuits, Solid Freeform Fabrication Symposium Proceedings, The University of Texas Press, Austin, 503-512.

B. Reilly and E. Brunet (2012) Accelerating Cure Times of Medical Silicone Adhesives with Infrared Radiation, Medical Design Briefs, online http://www.medicaldesignbriefs.com/component/content/article/13923.

M. Shoiher, K. Lozano, F.Rodriguez-Macias, and E. Barrera (2003) Nanofiber-reinforced polymers prepared by Fused Deposition Modeling. J. Applied Polymer Science, Vol. 89, 3081-3090.

R. Skubic, J. Comb, J. Grudem, W. Swanson, J. Batchelder, and S. Brose (2011) Viscosity pump for extrusion-based deposition systems, U.S. Pat. No. 7,891,964, February 22.

R. Vaidyanathan, J. Lombardi, J. Walish., S. Kasichainula, P. Calvert, and K. Cooper (1999) Extrusion Freeform Fabrication of Functional Ceramic Prototypes. Solid Freeform Fabrication Symposium Proceedings, The University of Texas Press, Austin. 327-334

J. Xiao, J. Otaigbe, and D. Jiles (2000) Modeling of magnetic properties of polymer bonded Nd-Fe-B magnets with surface modifications. J. Magnetism and Magnetic Materials 218, 60-66.

C. Zhu and J. E. Smay (2011) Thixotropic rheology of concentrated alumina colloidal gels for solid freeform fabrication. J. Rheol., 55, p. 655.

What is claimed is:

1. A multi-material additive manufacturing method for fabricating objects, the method comprising:
providing an extrusion printhead comprising a chamber, an orifice, at least two material flow channels communicating with the chamber, and a plunger able to controllably move within the chamber;
advancing a first material into the chamber through a first material flow channel;
extruding the first material through the orifice to form a first extrudate;
advancing the plunger into the chamber to substantially purge the first material;
withdrawing the plunger;
advancing a second material into the chamber through a second flow material channel;
extruding the second material through the orifice to form a second extrudate, wherein the second extrudate comprises substantially only the second material and substantially none of the first material.

2. The method of claim 1 wherein the rate of advancement of the first material is decreased and the rate of advancement of the plunger increased when the volume of the first material in the chamber is adequate to complete the first extrudate.

3. The method of claim 1 wherein the advancing the first material and the extruding the first material are substantially simultaneous.

4. The method of claim 1 wherein the extruding the first material and the advancing the plunger are substantially simultaneous.

5. The method of claim 1 wherein at least a portion of the plunger and the chamber are shaped according to geometric solids selected from the group consisting of spheres, cones, and cylinders.

6. The method of claim 1 wherein the withdrawing occurs subsequent to moving the orifice away from the extrudate.

7. A multi-material additive manufacturing method for fabricating objects, the method comprising:
providing an extrusion printhead comprising a chamber, an orifice, at least two material flow channels communicating with the chamber, and a rotating element;
advancing at least two materials into the chamber through separate material flow channels to contact the rotating element;
rotating the element to mix the materials; and
depositing the mixed materials through the orifice to form an extrudate, wherein the extrudate comprises a mixture of the at least two materials.

8. The method of claim 7 wherein the rotating element is a plunger able to advance into and substantially fill the chamber.

9. The method of claim 7 wherein the at least two materials differ in visual appearance.

10. The method of claim 7 wherein the at least two materials are components of a silicone elastomer.

11. The method of claim 7 wherein a volume of the first material advanced is different in magnitude from a volume of the second material advanced.

12. The method of claim 11 wherein the magnitudes vary continuously in time as the extrudate is formed.

13. The method of claim 7 where the rotating element can also translate within the chamber and substantially purge material from the chamber.

14. An additive manufacturing method for fabricating objects, the method comprising:
providing an extrusion printhead comprising at least one material flow channel, an orifice, and an energy source;
advancing at least one material requiring energy to cure through the at least one material flow channel and extruding it through the orifice to form an extrudate;
exposing the extrudate to energy from the energy source upon extrusion, wherein the extrudate is substantially cured.

15. The method of claim 14 wherein the energy source is a jet of heated gas.

16. The method of claim 14 wherein the energy source is infrared light.

17. The method of claim 14 wherein the energy source is a heated surface.

18. The method of claim 14 wherein the energy source is light.

19. The method of claim 14 wherein the printhead moves and the extrudate is deposited along a toolpath and wherein the exposing occurs to a region of the extrudate that has just been deposited.

20. The method of claim 14 wherein the energy source rotates around the orifice relative to the fabricated object.

21. The method of claim 14 wherein the energy source surrounds the orifice.
